(19) United States
(12) Patent Application Publication
(10) Pub. No.: US 2012/0035778 A1
(43) Pub. Date: Feb. 9, 2012

(54) AUTOMATED SYSTEM OF DEMOCRATIZING POWER

(76) Inventor: STEPHEN POH CHEW KONG, Vancouver (CA)

(21) Appl. No.: 13/240,488

(22) Filed: Sep. 22, 2011

Related U.S. Application Data
(62) Division of application No. 12/618,697, filed on Nov. 13, 2009.

(51) Int. Cl. G05B 15/02

(52) U.S. Cl. 700/295

(57) ABSTRACT

The present invention provides a system for providing democratizing power in a power grid system. In architecture, the system includes a module for receiving a plurality of user preferences concerning load shedding using a graphical user interface, and a module for implementing the user preferences during a grid irregularity.

### CROSS-REFERENCE TO RELATED APPLICATION

This application is a divisional application of U.S. patent application Ser. No. 12/618,697 filed on Nov. 13, 2009.

### BACKGROUND OF THE INVENTION

1. Field of the Invention

The present invention relates to a power grid, and more particularly to aggregating peer-to-peer distributed generators through a democratized power grid.

2. Description of Background

Currently, power grids are designed to incorporate and guarantee connectivity via multiple routes through what is known as a network structure. However, if the load is too heavy for one substation, it will fail and this extra load will be shunted to other routes, which eventually may fail, causing a domino effect. Current “smartgrid technologies” emphasize the use of information technologies (IT) and two-way using communication (such as via the Internet) to allow the existing electrical grid to operate more efficiently (e.g., to save consumers money and to reduce carbon dioxide emissions) and reliably and to provide additional services.

However, there is a low take up rate for innovative renewable energy technology equipment, even though many of them have existed for many years and are approaching commercialization. There is also an emphasis on the power grid companies, building and commercial enterprises to invest in expensive and untested new clean technologies, as well as sensing and measurement equipment, two-way integrated communications, advanced control, decision support systems and advanced components to monitor the performance of the grid. Accordingly, some of the renewable energy technology equipment is new and untested, and hence is prone to failure. Thus, renewable energy technology equipment typically requires constant monitoring and on-site maintenance by vendors and end-users.

Currently, a cocktail of energy management systems and software products known as demand response or demand management software are also available to enable utilities to meet rising demand for power and curtailing the need to build new power plants. However, these technologies require the installation of hundred of thousands of proprietary utility intelligent products across a service territory to create extra power capacity, including energy storage technologies, load measurement and control devices that will need heavy investment and risk of obsolescence by the utility companies themselves i.e. These technologies and devices could eventually “become dead end products” if the technology supplier folds. In addition, these technologies and control equipment are not networked and will require a significant and redundant amount of floor space for storage.

These demand response software management systems and Intelligent Energy Management Systems (IEMS) are proprietary and rely on a central control SCADA (“Supervisory Control and Data Acquisition”) dispatch system to aggregate distributed generators across a wide area, and they have a limited means to independently price signal (i.e., the onus is on power grids to make major decisions including protection from power outages, online energy management, and the integration of renewable energy sources). Since there is limited democratization and price signaling, these systems often direct the blame and guilt to the consumers for energy wastage and will often use a harsh and intrusive approach to modulate air conditioners, water heaters, and other appliances in exchange for a modest reduction in their utility bills. Also, there is also no safe means to aggregate power and send it back to the grid.

Also, consumer communication is a major bottleneck in implementing these intelligent software systems since a large number of market players must adhere to one common international standard and infrastructure. International Standardization bodies are finding it a monumental task to standardize different aspects of the smartgrid with so many different types of demand response signals and different pricing formats. Utility companies are also unsure as to how the different types of renewable equipment can integrate with the stringent requirement of the grid—and how these different building management software can communicate common signals and provide meaningful feedback to the grid. Also, different States across the same country may have adopted different standards so it will be confusing and a huge time investment and learning curve for customers who are trying to adopt these smartgrid technologies. Additionally, it is currently not economical to rig up a building with smartgrid sensors since the complex building automation systems and software standards almost always require customized implementation i.e. many do not adopt BACnet communication standards—and some may already have some form of energy management systems that may not be compatible with the electrical grid's. Moreover, at least some of the known devices that can be connected to a smartgrid have serious security vulnerabilities that could allow malicious attackers to seize local control of home utility networks.

Additionally with prior art systems, commercial and building entities would typically need to purchase stand-atone redundant batteries for energy storage and backup power would be used for only very short durations during their lifetime. Moreover, some of the advanced batteries and fuel cell components are expensive and require frequent replacement and costly preventive maintenance.

While many of types of equipment today deploy renewable energy technologies, these equipment types are fixed and operate on a “closed” system that offers consumers little choice and variety. Thus, there is a risk that these technologies may become “dead end” products that will not work on a different system without a major overhaul or upgrade.

### SUMMARY OF THE INVENTION

In example embodiments, the present invention provides a system for democratizing power in a power grid system. Briefly described, in architecture, one embodiment of the system, among others, can be implemented as follows. The system includes a module for receiving a plurality of user preferences concerning load shedding using a graphical user interface, and a module for implementing the user preferences during a grid irregularity.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for power devices utilizing the power monitoring system of the present invention.

FIG. 2 is a block diagram illustrating an example of the component subsystems utilized in the meta-exchange system.

FIG. 3A is a block diagram illustrating an example of a server device utilizing the meta-exchange system with the power monitoring system of the present invention, as shown in FIGS. 1 and 2.

FIG. 3B is a block diagram illustrating an example of functional elements in the remote monitoring device to provide for the power monitoring system of the present invention, as shown in FIGS. 1-3A.

FIG. 4 is a flow chart illustrating an example of the operation of the power monitoring system of the present invention, as shown in FIGS. 1, 2B and 2C.

FIG. 5 is a flow chart illustrating an example of the operation of the new customer process utilized by the power monitoring system of the present invention, as shown in FIGS. 2, 3A and 4.

FIG. 6 is a flow chart illustrating example of the operation of the premium subscription process utilized by the power monitoring system of the present invention, as shown in FIGS. 2, 3A and 4.

FIG. 7 is a flow chart rating an example of the operation of the normal operation process utilized by the power monitoring system of the present invention, as shown in FIGS. 2, 3A and 4.

FIG. 8 is a flow chart illustrating an example of the operation of the normal green operation process utilized by the power monitoring system of the present invention, as shown in FIGS. 2, 3A and 4.

FIG. 9A-B area flow chart illustrating an example of the operation of the normal load leveling process utilized by the power monitoring system of the present invention, as shown in FIGS. 2, 3A and 4.

FIG. 10A-B are a flow chart strafing an example of the operation of the emergency power process utilized by the power monitoring system of the present invention, as shown in FIGS. 2, 3A and 4.

FIG. 11A-B are a flow chart illustrating an example of the operation of the power outage process utilized by the power monitoring system of the present invention, as shown in FIGS. 2, 3A and 4.

FIG. 12A-C are a flow chart illustrating an example of the operation of the cyber attack process utilized by the power monitoring system of the present invention, as shown in FIGS. 2, 3A and 4.

FIG. 13 is a schematic diagram illustrating an example of a digital dashboard utilized by the power monitoring system of the present invention, as shown in FIGS. 2, 3A and 4.

FIG. 14 is a schematic diagram illustrating an example of a digital dashboard map utilized by the power monitoring system of the present invention, as shown in FIGS. 2, 3A and 4

FIG. 15 is a schematic diagram illustrating an example of a digital dashboard adjustments utilized by the power monitoring system of the present invention, as shown in FIGS. 2, 3A and 4.

FIG. 16 is a schematic diagram illustrating an example of a digital dashboard preferences utilized by the power monitoring system of the present invention, as shown in FIGS. 2, 3A and 4

FIG. 17 is a schematic diagram illustrating an example of a typical remote connection diagram for the power monitoring system of the present invention, as shown in FIGS. 2, 3A and 4.

FIG. 18 is a schematic diagram illustrating an example of the changes in our charging and discharging through a typical day for the power monitoring system of the present invention, as shown in FIGS. 2, 3A and 4

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, conditions or parameters described and/or shown herein, and that the terminology used herein is for the purpose of describing particular embodiments by way of examples only and is not intended to be limiting of the claimed invention. Any and all patents and other publications identified in this specification are incorporated by reference as though fully set forth herein.

The present invention incorporates In order to mitigate and reverse climate change and peak oil shortages, a system of the present invention improves the efficiency and reliability of the power grid through aggregating peer-to-peer distributed generators through a democrarized wed 2.0 or better meta-exchange system that can effectively conduct “price signaling” and energy trading through a suitable existing software technology. These Web 2.0 software system come with standardized communication and database reporting formats such as XML and HXML that will eliminate the need for new smartgrid communication protocols.

The present invention avoids fault tolerance by democratizing power generation, thereby allowing individual customers to generate power onsite using whatever generation method they find appropriate and aggregating this power to reduce the load of the power grid during peak periods. This hybrid or recombination technique can also allow individual users (or a community of users) to tailor their generation and consumption directly to their own load (i.e., Grid-tie), making them independent from grid power failures. By enabling “democratized” distributed generation, resources such as residential solar panels, modular stationary power systems, and small wind and plug in hybrid electrical vehicles, the present invention provides and encourages users (such as those owning individual homes and businesses) to “farm energy” and sell power to their neighbors or back to the grid through a meta-exchange in exchange for a profit. Similarly, larger commercial businesses that have existing renewable or back-up power systems can similarly farm energy and provide power to others. During peak demand times (such as in the summer months when air condition units place a strain on the grid), users selling power can be paid a higher price for that power (i.e., dynamic gate management or “Real Time Pricing (RTP)”). Additionally, the present invention allows its user to determine the amount of load shedding during particular periods of time.

Advantageously, the systems of the present invention allows and motivates all users to “play a part” in energy reduction since they can continuously track energy prices (“price signaling”) through the Internet and mobile devices and determine when a potential buyer will offer them the highest rates. Additionally, the systems of the present invention provide a continuously scalable power source (even once a building structure is completed) and an option (incentive) for off-peak charging and automatically awarding carbon credits (such as when a user switches to renewable energy technology and/or waste energy). Moreover, the systems of the present invention minimize (if not eliminate) the need to dedicate a large amount of physical floor space in a single location for power storage, generation and backup equipment since it can be decentralized through advanced web 2.0 peer-to-peer aggregating technologies (or other suitable technology) that is managed through a subscription plan; the need for individuals and businesses to purchase expensive equipment to provide backup/premium power; the need for constant monitoring and maintenance of backup equipment by end users; the need for noisy diesel generators; and the use of large banks of batteries (which are expensive, take up a large footprint, and require costly preventive maintenance).

Also advantageously, the systems of the present invention can make use of and be implemented with existing equipment and technology (such as power lines, existing home panels, renewable energy sources, etc.) that are already installed to allow the aggregated power to flow back to the power grid en masse to counter voltage dips and other instability. For example, it is believed that the majority of power meters worldwide are electromechanical meters and except for a few more progressive utility companies, most regulators are very conservative in using untested technologies on a critical infrastructure. Systems of the present invention can provide the option to shift the decision-making and subscription cost to the fringes using intelligent neural networks, instead of relying on the communication signals and heavy infrastructure investment (such as the smartmeters) by the utility companies. A system according to one example embodiment of the present invention combines neural network technology with suitable intelligent management software to enhance the overall safety and security of the smartgrid system. This can by done through system integrating with existing and commercially available software and allowing the meta-exchange to bunch up these individual stand-alone storage systems so that there is a wide-area aggregation capability built-in. Additionally, a system of the present invention can act as a “plug and play” system that is “open” and compatible. Moreover, such system can bolt onto electromechanical systems as well as most digital smart meters independent from the grid. Additionally, such system can also include hardware to communicate through one or more media, such as power line communication or power line carrier (PLC) or power line networking (PLN), optical fibers, RF, BPL, Wi-Fi, WiMAX, and ADSL lines without requiring any standardization in protocol or standards. Additionally, such system can also include hardware to communicate over a network, such as but not limited to a local area network (LAN), a personal area network (PAN), a campus area network (CAN), a metropolitan area network (MAN), a wide area network (WAN) or a combination of any of the above. These networks may include but are not limited, to the Internet, a telephone line using a modem (POTS), Bluetooth, WiFi, cellular, optical, satellite, RF, Ethernet, magnetic induction, coax, RS-485, and/or other like networks. Power line communication or power line carrier (PLC), also known as Power line Digital Subscriber Line (PDSL), mains communication, power line telecom (PLT), or power line networking (PLN), is a system for carrying data on a conductor also used for electric power transmission. Broadband over Power Lines (BPL) uses PLC by sending and receiving information bearing signals over power lines to provide access to the Internet.

Also, using these hybrid systems, whenever the power grid faces a malicious cyber attack or senses any hacking to the communication lines, the meta-exchange can automatically devolve power to the fringes (i.e., fragment and break up into tiny autonomous microislands or hive off an specific zone in an emergency situation where a small part of a grid is actually bringing down the entire grid) and automatically restore control when an emergency situation is over. This intrusion sensing can be done through commercially, available fiber optic intrusion detection systems that are well known to the art and “fragmentation” (or “sectionalization configuration algorithms”) can be achieved through interfacing these sensors with existing and commercially available automatic dispatching systems through signals that are initiated and controlled by the meta-exchange.

The meta-exchange also adds intelligent sensors to the grid. The sensors continuously monitor voltage, current, frequency, harmonics as well as condition of feeders and current breakers and are embedded onto the renewable energy and storage equipment, which can provide new information to decision makers during times of peak load, and emergency. These smart sensors, when interfaced with commercially available artificial intelligence and simulation software packages, can also allow these “micro-islands” to adapt and morph during times of emergency and peak loading and automatically restore the system back to normal when the emergency is over through the use of simulation and artificial intelligence software packages

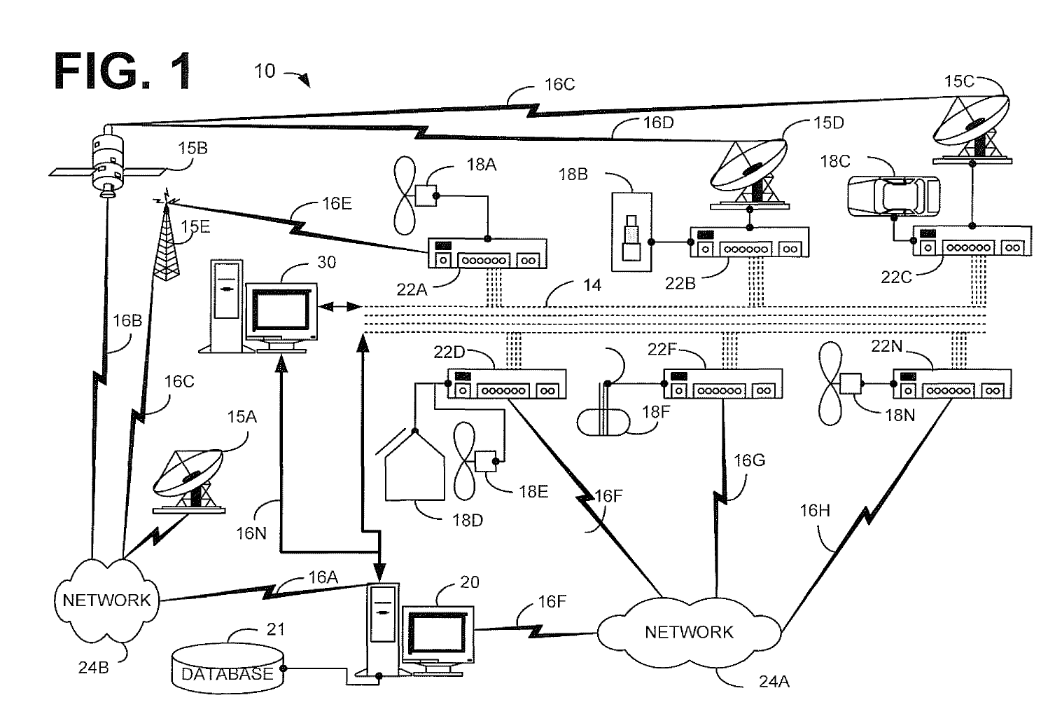

With reference now to the drawing figures, wherein like reference numbers represent corresponding parts throughout the several views, FIG. 1 shows a functional block diagram illustrating the system architecture of a system 10 for democratizing power to create a meta-exchange and a Meta Grid or virtual power plant. The system 10, through use of various subsystems and user inputs, controls the flow of power in a power grid 14 that connects a plurality of renewable energy sources/devices 18A-18N. Such renewal energy sources/devices 18A-18N can include, but not limited to, residential solar panels, modular stationary power systems, small wind and plug in hybrid electrical vehicles, wind generators, hydro-electric turbines, solar electric systems, or any device that can generate power through harvestable braking motion, including elevators, roller coasters, Ferris wheels, light rail train systems, etc. The system 10 provides its users a way to buy as much (or as little) power it needs, and assuming the user has at least one renewable energy source connected to the system, the system 10 also provides a way for the user to sell power. In other words, in an example embodiment, the users control the flow of energy in a peer-to-peer (P2P) type of environment, even though the physical electrons will not necessarily flow in a peer-to-peer manner.

The system 10 can make use of existing infrastructure, such as power lines, generators, etc. In an example embodiment, the users of the system 10 control the flow of energy; however, a system operator can monitor such usage, perform maintenance, etc.

The system 10 includes a meta-exchange, mission control center, or server 20 having a computer processor 41 and at least one computer-readable storage medium 42. The computer-readable storage medium can be any suitable information storage unit, such as any suitable magnetic storage or optical storage device, including magnetic disk drives, magnetic disks, optical drives, optical disks, and memory devices, including random access memory (RAM) devices, and flash memory.

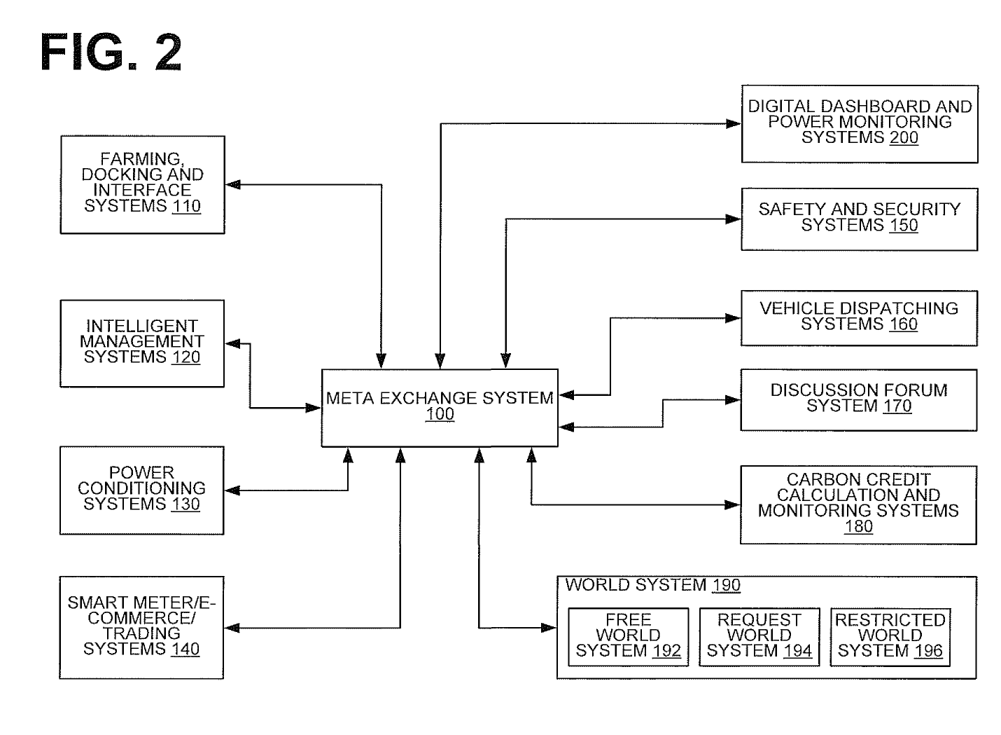

The meta-exchange, mission control center or server 20 communicates with a plurality of user communication devices or black boxes) 22A-22N and alerts providers/users connected to the power grid 14 through the use of a plurality of subsystems, as shown in FIG. 2, via a communications network 24. The communications network 24 preferably is a global computer network such as the Internet. The system 10 preferably is implemented as an application service (i.e. Web 2.0) provided on the Internet. In an example embodiment, the server 20 is a bank of computer servers with a scalable architecture that is remotely located relative to the user devices 22A-22N The user devices 22A-22N can be desktop computers, laptop computers, hand-held computers, PDA's, web-enabled phones, smart phones or other like communication devices connected to the communications network 24. In alternative embodiments, the communications network 24 is provided by a wireless cellular network or another computer-based network.

As described in more detail herein, each user communication device (or black box) 22A-22N communicates or directly interfaces with one or more renewable power devices 18A-18N. Typically, these renewable energy or demand response equipment are owned by the user, although in alternative embodiments, these renewable energy equipment 18A-18N can be owned by a party other than the user.

The server 20 manages the power grid 14 through the plurality of systems or subsystems, which are depicted in detail in FIG. 2. The subsystems 12 can include one or more of the following: a farming/docking and interfacing system 110, an intelligent management system 120, a power conditioning system 130, an e-commerce/trading system 140, a safety and security system 150, a vehicle dispatch system 160, a discussion forum system 170, a carbon credit calculation and monitoring system 180, a world system 190 and a digital dashboard and power monitoring system 200. Additionally, the system may include a plurality of each of the individual subsystems.

The docking and interfacing system 110 includes suitable sensors, microprocessors, and software protocols communicatively coupled to each renewable energy device 18A-18N. These sensors, microprocessors, and software protocols are preferably used to determine the compatibility of new equipment (i.e., new renewable energy devices) connected to the power grid 14. These sensors, microprocessors, and software protocols can also be used to determine the type, the make, tampering and the limitations of the equipment connected to the power grid 14. Preferably, entry rules and protocols for new equipment, including the environmental protection it offers, are preset and stored on a suitable computer readable medium accessible by the docking and interfacing system 110. Additionally, the data acquired through the docking and interfacing system 110 can be stored on a suitable database, embedded microchip technology or computer readable medium. Additionally, hardware interfaces can be available to track identification and theft. For example, adaptive islanding technology collects and tracks the consumers' (or members') history, load, equipment type, etc in a database, which can then be used to determine each consumer's priority (during a blackout, for instance) and to determine if there is anything that is unusual (about the load profile and characteristics) before activating the appropriate switches and relays.

In another embodiment, these docking and interfacing system 110 can be advanced netmetering systems, inverters and power conditioning systems. In this embodiment, the docking and interfacing system 110 can serve as a conduit to an urban energy farm whereby this technology can offer new sources of income for people who are at now caught at the margins due to the economic and financial crisis and help mitigate homelessness. The harvested energy (such as from solar technology) generated can be stored, bidded and sold to various interested parties through a docking system. As such, members can subscribe to various levels of microfarming options—and at the very basic tier, it can be provided to them as a freebie or a low cost if they agree on a longer term fixed subscription plan—or perhaps take on a long term farming contract with the power grid at a fixed futures price. The meta-exchange system 100 can also support all sorts of other forms of backyard energy farming including regenerative fuel cell power, algae biodiesel production, and wind farming to supply power back to the grid.

The power monitoring system 200 also interfaces with the e-commerce/trading system 140. These e-commerce/trading systems [or Advanced Metering Infrastructure (AMI)] receive data from the intelligent management system 120 regarding the power bought and sold by each user and then calculates the net price of power bought and sold by each user. For example, the e-commerce/trading system 140 can include an algorithm to calculate the exact charges, which will be debited/credited to each user according to the mode of payment that was preselected by the user e.g., credit card, checking account, PayPal™, etc.). In addition, the c-commerce/trading systems 140 can also automatically issue and monitor carbon credits.

In another embodiment, the docking systems can include netmetering and other intelligent power metering equipment that is able to monitor and automatically update the pricing and cost on the meta exchange control center on a real time basis once energy is being discharged. This equipment can be leased to members according to their subscription plan with a fixed discount on their utility rates. In addition, democratization allows for a green investment asset class that is attractive for a financial institution to offer project financing and securitization of carbon credits. Moreover, the system of the present invention provides the additional capability and option to trade this equipment with or without the carbon credits and these options can be defined through the web 2.0 Meta exchange.

Additional revenues for the system operator can be achieved through a tip jar (i.e. revenue sharing), kudos, reputation management fees, syndication, affinity credit cards. DRM fees, users group charges, revenue sharing, strategic alliances, facilities management, mobile phone company split revenues, subscription fees, selling advertisement, and/or fees to port content to wireless carrier.

The power conditioning system 130 includes a plurality of power conditioning devices having technology and hardware, which are well known in the art. However, if the renewable energy device is a vehicle (i.e., a V2G system), a common direct current bus (i.e., an inverter) can be used for input into a DC to AC power conversion device. Once put through the inverter, the AC output of the inverter becomes the input to the AC bus, which supply local loads or interface directly to the power grid 14 according to the rules defined by the power monitoring system 200. The power conversion device can optionally include electrical relaying, fault isolation protection, voltage regulation equipment, and metering.

The vehicle dispatch system 160 communicates with a plurality of in-vehicle units, each preferably comprising a smartcard, of electric vehicles having power equipment connected to the power grid 14. The in-vehicle unit can include a suitable GPS device, such as a GPS based multi-sensor positioning system, that provides a reliable positioning system to determine vehicle location. The in-vehicle unit can further be configured like a “smartmeter” to automatically calculate the power discharged from the batteries of the electric vehicle and remit the necessary funds to the consumer through their cellular phone or other electronic payment system. Preferably, the vehicle charges the power grid 14 (or receives power from the power grid 14) only when it is connected to the grid at a specific point or location. For example, there may be one or more locations in any given area for interfacing the vehicle with the power grid 14. Such locations can include a user's home (house, apartment, etc.), a user's office, a gas station, or any other suitable location that provides a connection to the power grid and that allows the GPS satellite to locate and identify the vehicle such that a handshaking process can occur.

For example, the in-vehicle unit can be an e-commerce/trading “smartmeter” system that includes a GIS based energy charge table, which includes the current discharging pricing algorithms. Additionally, the discharging pricing algorithms can be configured for each charging location. The in-vehicle unit can further include a cellular mobile set that is embedded in the unit to transmit status information from the smartcard to the server 20. Wireless communication can also be used as a form of enforcement to identify any illegal or unauthorized vehicle.

Additionally, such a vehicle dispatch system 160 can be used when the demand for power increases throughout the day or in the event of an emergency blackout situation. In such situations, the in-vehicle unit can be alerted through the dispatch system, which uses GPS tracking to detect vehicles within a certain proximity. The dispatch system can broadcast a request to recall fleet vehicles to a “base,” where the vehicles connect back to the power grid 14 and feed power into the grid. Additionally, the in-vehicle units can further be configured as a “smartmeter” to automatically calculate the power discharged from the batteries of the electric vehicle and remit the necessary funds to the consumer through their cellular phone or other electronic payment systems.

Additionally, vehicle-dispatching systems 160 can include anything mobile that can generate power, including elevators, roller coasters, Ferris wheels, and personal light rail train system or any other device has harvestable power from braking motion. In one embodiment, a centralized fleet management system can be dispatched through the meta-exchange system 100. Each vehicle can have its own autonomous control system that is capable of location detection, automatic energy calculation and e-commerce. This information can then be communicated and fed back to the Meta control center via cellular phone, satellite systems or other RE and wireless communication means to continuously update the system. During any peak load or in any emergency situations, the centralized fleet management system can broadcast these signals, which can be displayed in each vehicle through a suitable dashboard or device.

The meta-exchange system 100 can also have the ability to track and locate vehicles by interfacing with the fleet management systems that are within a specified distance from an emergency situation and subsequently direct these assigned or targeted vehicles to the affected location.

The safety and security system 150 provides a plurality of fail-safe features (such as sensors coupled to switches) that detects a failure in the system and effectively shuts down the distributed generator or a portion thereof in an emergency situation. A failure in the system can occur when current flows in the opposite direction where the reach of the relay is shortened, thereby leaving high impedance faults undetected. For example, when a utility breaker is opened, a portion of the utility system remains energized even though it may be isolated from the remainder of the utility system. Such energized system can cause injuries to the users, utility personnel, and the system operator. The safety and security system 50 thus would detect this failure and shut down the appropriate portion of the system.

The digital dashboard and power monitoring system 200 includes a programmable microcontroller to manage power consumption and storage in the distributed power grid 14. Preferably, measurements are received from a plurality of geographically distributed energy management controllers coupled to the renewable energy devices, and these measurements are processed and displayed on a graphical user interface (e.g., a demand response dashboard), such as on the user communication device (or black box) 22. The digital dashboard and power monitoring system 200 gives commands to either discharge (or conversely charge) each renewable energy device's stored energy into the power grid 14 in accordance with user defined rules and requirements (such as economics, during routine backups, load balancing, load shedding, and limits). Preferably, the power delivery and demand response dashboard (i.e., graphical interface) is available online (i.e., accessible via the communications network 24) to each user and system operator for decision-making and for diagnosis and detection of any fault or incident in the system 10. The digital dashboard and power monitoring system 200 provides inputs to the intelligent management system 120 through communicating with a plurality of building automation and metering systems to collect, archive, analyze and communicate energy information and storing this in a database. By aggregating the management of building-level energy consumption and production, the graphical user interface can also display information to (or educate) building managers on energy use and demand charges. Additionally, the digital dashboard and power monitoring system 200 can provide the users load shedding capabilities, as described in more detail herein.

The intelligent management system 120 includes a controller/dispatcher (not shown) operable to network and interface with different sources of the auxiliary power system including fuel cell, solar power, electrical grid, vehicle-to-grid systems as well as regenerative braking systems. Preferably, the controller/dispatcher is configured to determine the energy need, in the “manual mode” embodiment, the meta-exchange or server 20 communicates an energy request signal to one or more user (peer-to-peer) communication devices 22 in the system 10 using appropriate technology or protocols (e.g., Web 2.0). For example, the server 20 can broadcast an email/text message invitation to one or more communication devices 22, and the user of each communication device can either accept or reject the invitation either in real time or in a delayed mode. If the energy request is accepted by one of the user devices 22A-22N, then the controller/dispatcher initiates the transfer of requested energy from the accepting user communication device 22 to the power grid 14.

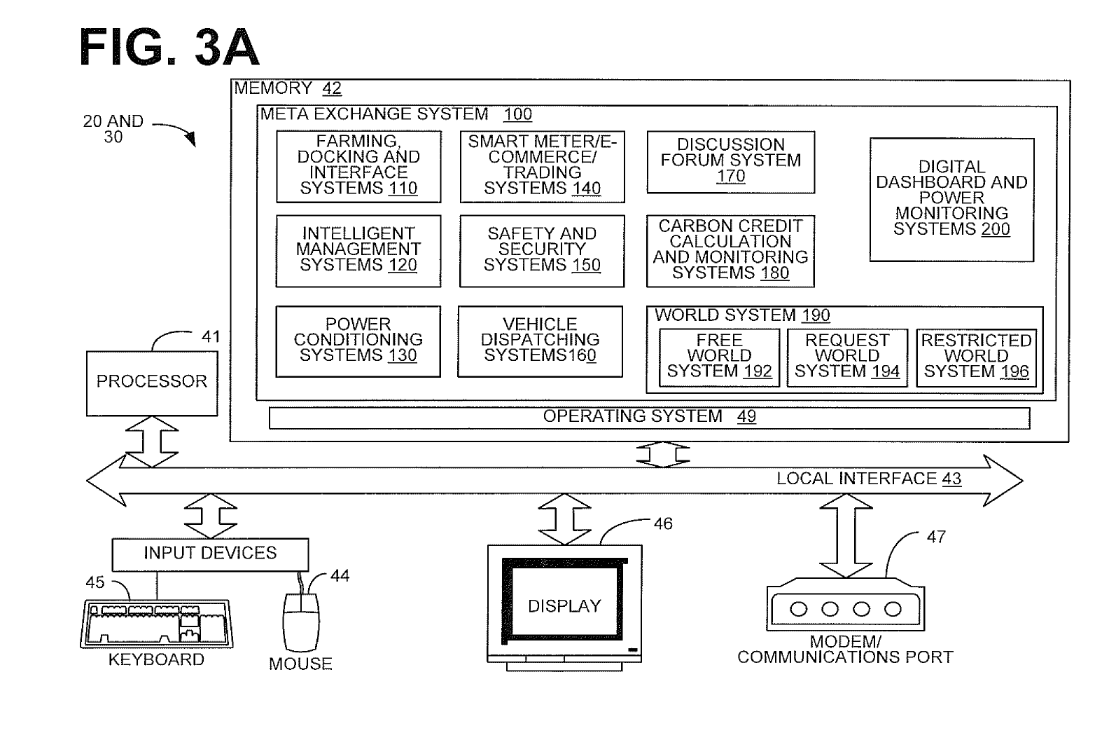

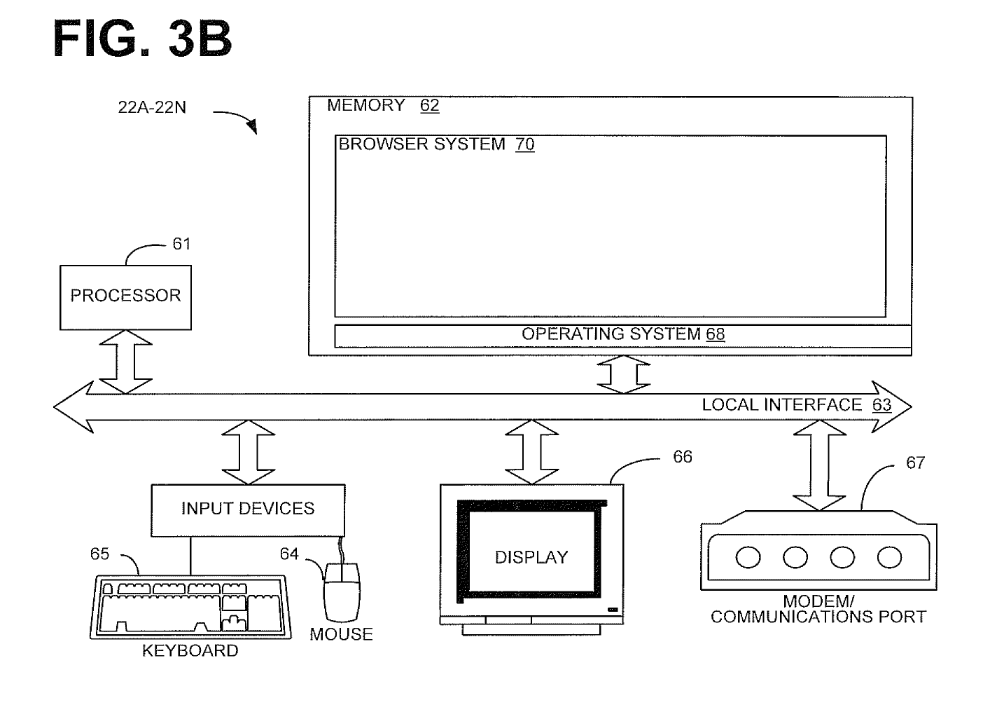

FIG. 3A is a block diagram illustrating an example of a server 20 utilizing the meta-exchange system 100 with the power monitoring system 200 of the present invention, as shown in FIGS. 1 and 2. Examples of server 20 include, but are not limited to, PCs, workstations, laptops, PDAs, palm devices, smart phone, and the like. Illustrated in FIG. 3B is an example demonstrating the user communication device 22(A-N) that interact with the power monitoring system 200 of the present invention. The processing components of the third party supplier computer systems 30 are similar to that of the description for the server 20 (FIG. 3A).

Generally, in ter ins of hardware architecture, as shown in FIG. 3A, the server 20 includes a processor 41, memory 42, and one or more input and/or output (I/O) devices (or peripherals) that are communicatively coupled via a local interface 43. The local interface 43 can be, for example, one or more buses or other wired or wireless connections, as are known in the art. The local interface 43 may have additional elements, which are omitted for simplicity, such as controllers, buffers (caches), drivers, repeaters, and/or receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom-made or commercially available processor, a central processing unit (CPU), a data signal processor (DSP) or an auxiliary processor among several processors associated with the server 20, or a semiconductor-based microprocessor (in the form of a microchip) or a macroprocessor. Examples of suitable commercially available microprocessors include, but are not limited to, the following: an 80×86 or Pentium® series microprocessor from Intel® Corporation, U.S.A., a PowerPC® microprocessor from IBM®, U.S.A., a Sparc™ microprocessor from Sun Microsystems®, Inc., a PA-RISC™ series microprocessor from Hewlett-Packard Company®, U.S.A., a 68xxx series microprocessor from Motorola Corporation®, U.S.A. or a Phenom™, Athlon™, Sempron™ or Opteron™ microprocessor from Advanced Micro Devices®, U.S.A.

The memory 42 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 3A, the software in the memory 42 includes a suitable operating system (O/S) 49, a meta-exchange system 100 and the power monitoring system 200 of the present invention. As illustrated, the meta-exchange system 100 comprises numerous functional components including, but not limited to a farming/docking and interfacing system 110, an intelligent management system 120, a power conditioning system 130, an e-commerce/trading system 140, a safety and security system 150, a vehicle dispatch system 160, a discussion forum system 170, a carbon credit calculation and monitoring system 180, a world system 190 and a digital dashboard and power monitoring system 200.

A non-exhaustive list of examples of suitable commercially available operating systems 49 is as follows (a) a Windows/Vista operating system available from Microsoft Corporation; (b) a Net ware operating system available from Novell, Inc.; (c) a Macintosh/OS X operating system available from Apple Computer, Inc.; (e) an UNIX operating system, which is available for purchase from many vendors, such as but not limited to the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (such as for example Symbian OS available from Symbian, Inc. PalmOS available from Palm Computing, Inc., OS X iPhone available from Apple Computer, Inc., and Windows CE available from Microsoft Corporation).

The operating system 49 essentially controls the execution of other computer programs, such as the power monitoring system 200, and provides scheduling, input-output control, file and data management, memory management, and communication control and related services. However, it is contemplated by the inventors that the power monitoring system 200 of the present invention is applicable on all other commercially available operating systems.

The power monitoring system 200 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the power monitoring system 200 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote dispensing devices, other files, devices, systems, or a network), a radio frequency (RF) or other transceiver (not shown), a telephonic interface (not shown), a bridge (not shown), a router (not show and/or the like.

If the server 20 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only memory, such as ROM, PROM, EPROM, EEPROM or the like, so that the BIOS can be executed when the server 20 is activated.

When the server 20 is in operation, the processor 41 is configured to execute software instructions stored within the memory 42, to communicate data to and from the memory 42, and generally to control operations of the server 20 pursuant to the software. The power monitoring system 200 and the O/S 49 instructions are read, in whole or in part, by the processor 41, perhaps buffered within the processor 41, and then executed.

When the power monitoring system 200 is implemented in software, as is shown in FIG. 2A, it should be noted that the power monitoring system 200 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RAY) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the power monitoring system 200 is implemented in hardware, the power monitoring system 200 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 3B is a block diagram demonstrating an example of functional elements in the user communication device 22(A-N) that enable access to the power monitoring system 200 of the present invention, as shown in FIG. 2A. The user communication device 22(A-N) provide access to power monitoring and power democratization by accessing information in server 20 and database 11. This information can be provided in a number of different forms including, but not limited to, ASCII data, WEB page data (e.g. HTML), XML or other type of formatted data.

Included with each user communication device 22(A-N) is a browser system 70. The browser system 70 is utilized to provided interaction with the meta-exchange system 100 and power monitoring system 200 of the present invention.

The software in memory 62 may include one or more separate programs, each of which comprises an ordered listing of executable instructions for implementing logical functions. In the example illustrated in FIG. 3B, the software in the memory 62 includes a suitable operating system (O/S) 68 and the browser system 70.

As illustrated, the user communication device 22(A-N) each include components that are similar to components for server 20 described with regard to FIG. 2A. Hereinafter, the user communication device 22(A-N) will be referred to as the user communication device 22 for the sake of brevity.

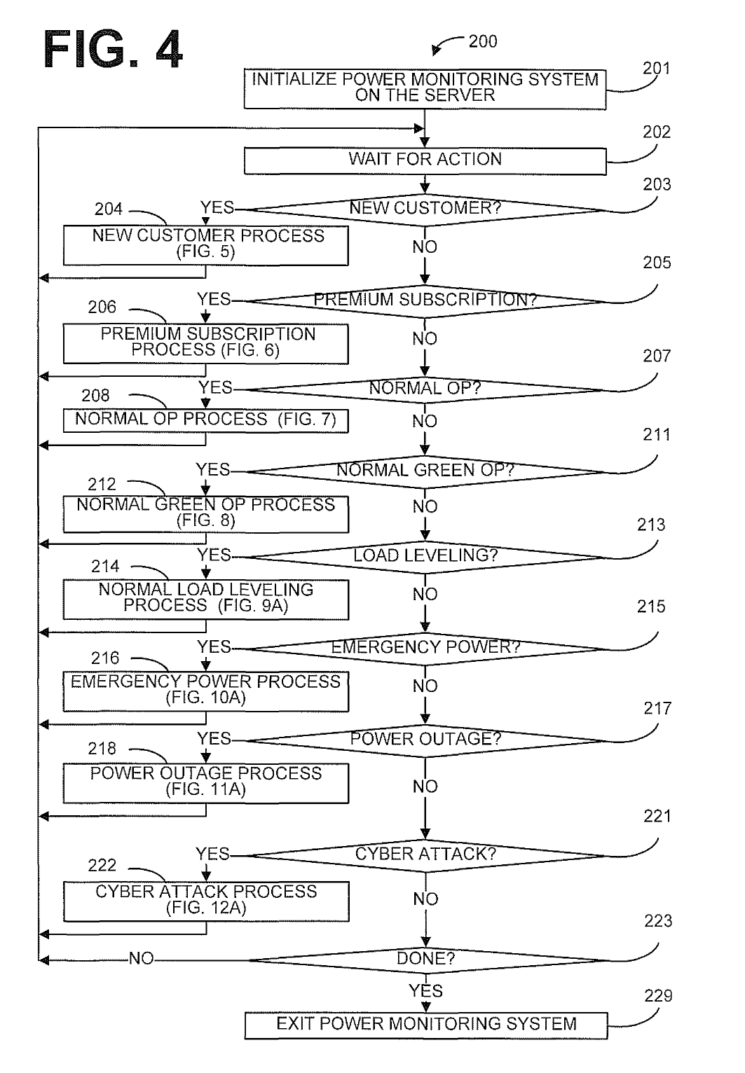

FIG. 4 is a flow chart illustrating an example of the operation of the power monitoring system of the present invention, as shown in FIGS. 1, 2B and 2C. The power monitoring system 200 of the present invention provides for management power consumption and storage in a distributed power grid 14. Preferably, measurements are received from a plurality of geographically distributed energy management controllers coupled to the renewable energy devices 18A-18N and these measurements are processed and displayed on a graphical user interface (i.e. a GUI) on the users communication device 22.

First at step 201, the power monitoring system 200 is initialized on server 20. This initialization includes the startup routines and processes embedded in the BIOS of the server 20. The initialization also includes the establishment of data values for particular data structures utilized in the power monitoring system 200.

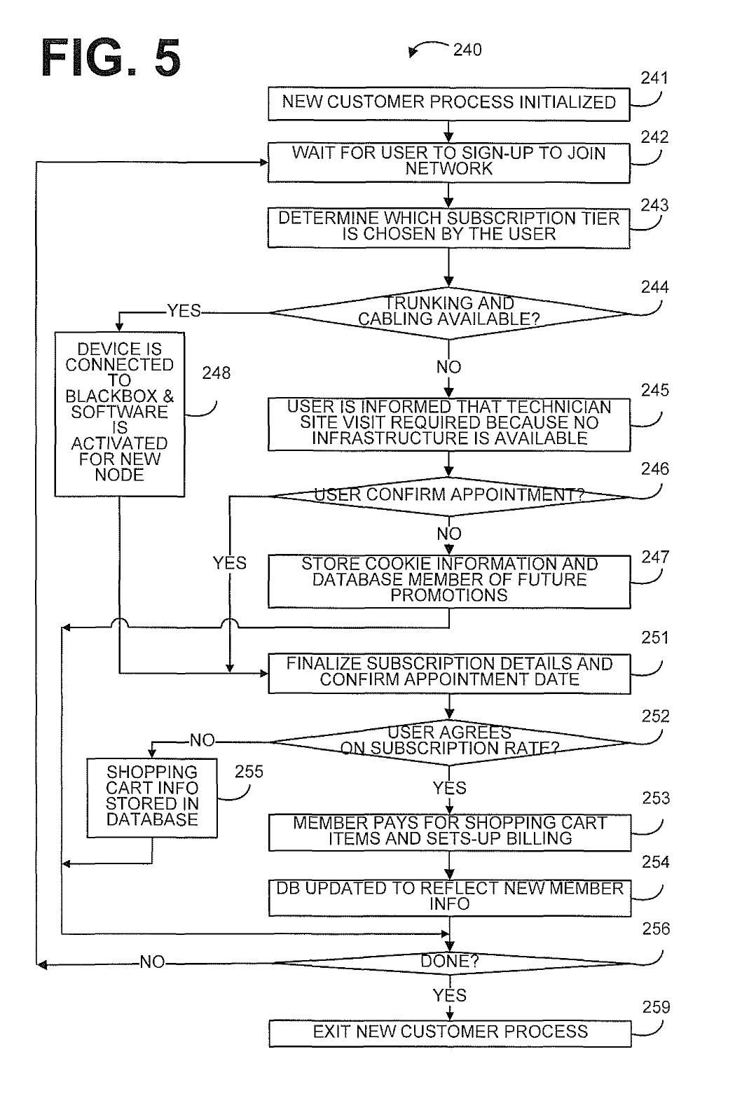

At step 202, the power monitoring system 200 waits to receive an action to be process. When an action is received, it is first determined if the action is to register a new customer at step 203. If it is determined in step 203 that the action is not to register a new customer, then the power monitoring system 200 proceeds to step 205. However, if it is determined at step 203 that the action is to register a new customer, then the power monitoring system 200 performs the new customer process at step 204. The new customer process is herein defined in further detail with regard to FIG. 5. After performing the new customer process at step 204, the power monitoring system 200 returns to step 202 to wait for the next action.

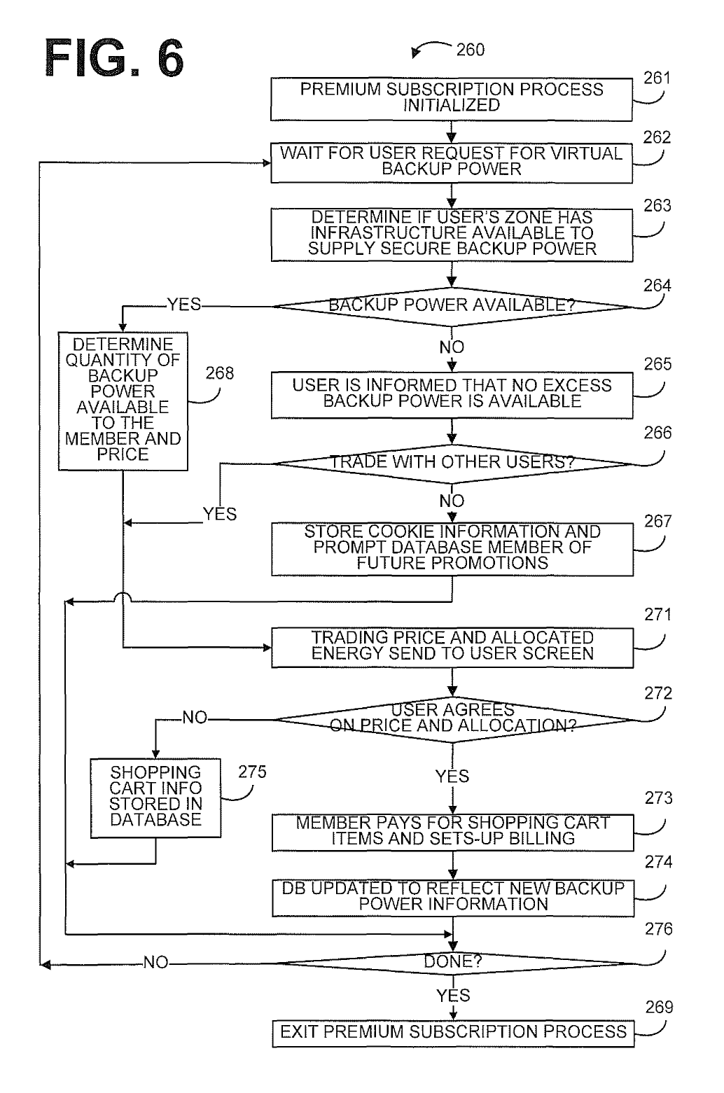

At step 205, it is determined if the action is to register a premium subscription. It is determined at step 205 that the action is not to register a premium subscription, then the power monitoring system 200 proceeds to step 207. However, if it is determined at step 205 that the action is to register a premium subscription, then the power monitoring system 200 performs the premium subscription process at step 206. The premium subscription process is herein defined in further detail with regard to FIG. 6. After performing the premium subscription process at step 206, the power monitoring system 200 returns to step 202 to wait for the next action.

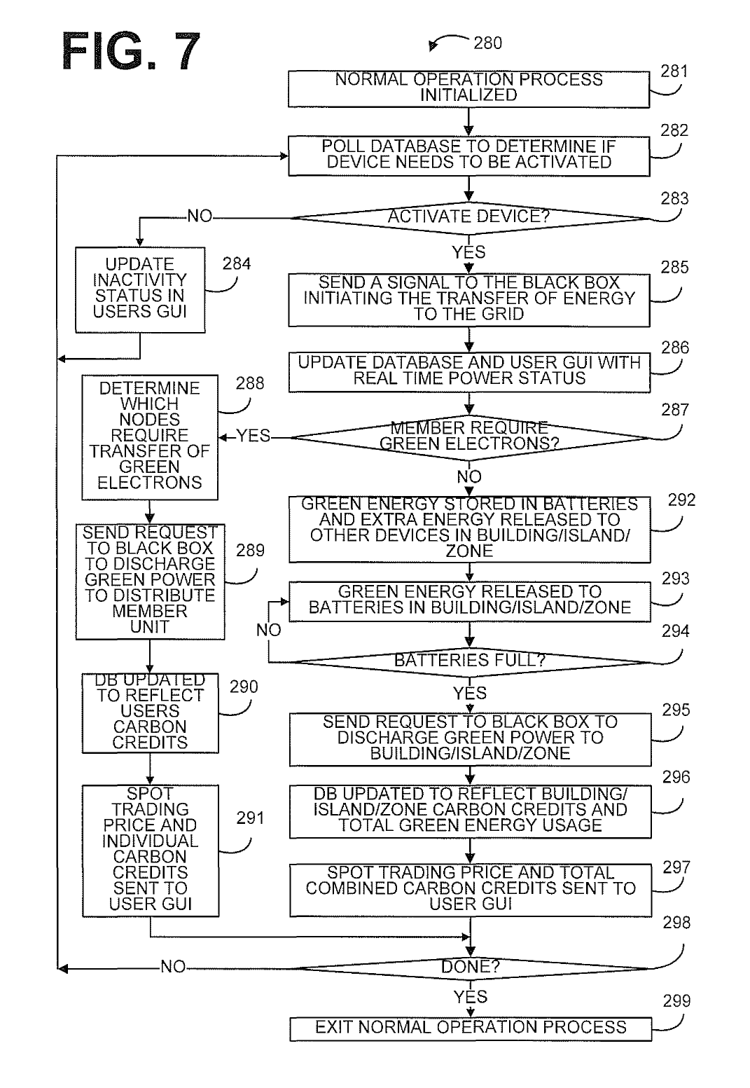

At step 207, it is determined if the action is to continue normal operations. It is determined at step 207 that the action is not continue normal operations, then the power monitoring system 200 proceeds to step 211. However, if it is determined at step 207 that the action is to continue normal operations, then the power monitoring system 200 performs the normal operations process at step 208. The normal operations process is herein defined in further detail with regard to FIG. 7. After performing the normal operations process at step 208, the power monitoring system 200 returns to step 202 to wait for the next action.

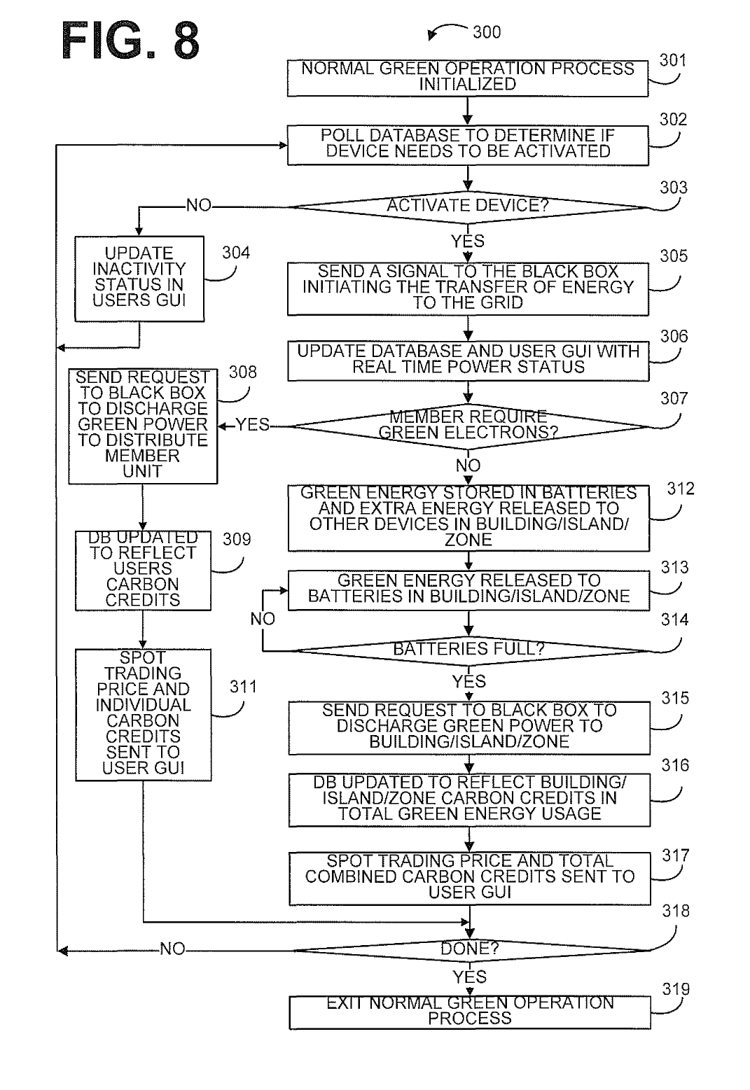

At step 211, it is determined if the action is to perform a normal green operation. It is determined at step 211 that the action is not to perform a normal green operation, then the power monitoring system 200 proceeds to step 213. However, if it is determined at step 211 that the action is to perform a normal green operation, then the power monitoring system 200 performs the normal green operation process at step 212. The normal green process is herein defined in further detail with regard to FIG. 8. After performing the normal green operation process at step 212, the power monitoring system 200 returns to step 202 to wait for the next action.

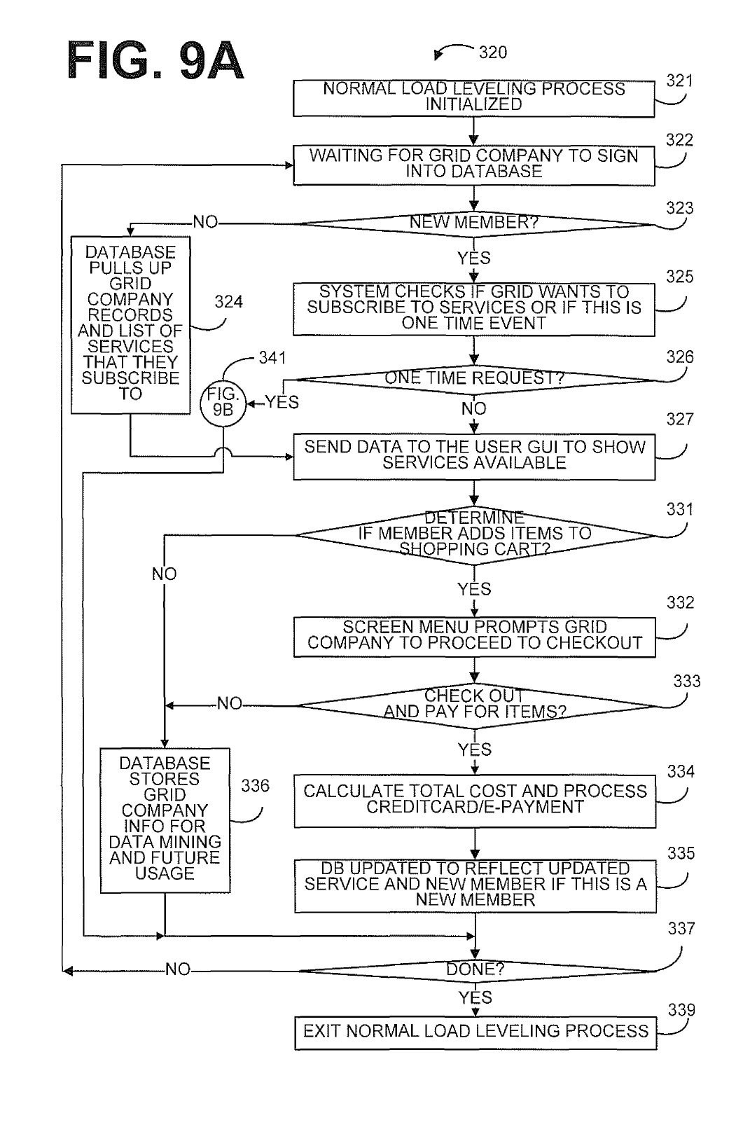

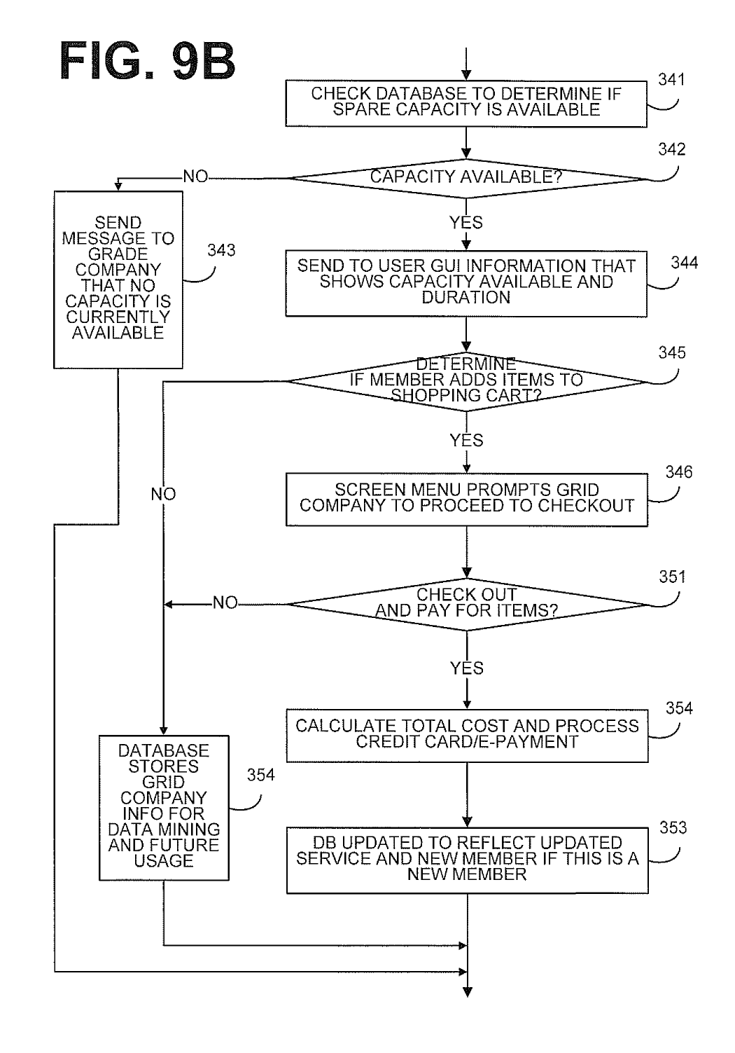

At step 213, it is determined if the action is to perform a normal ad leveling operation. It is determined at step 213 that the action is not to perform a normal load leveling operation, then the power monitoring system 200 proceeds to step 215. However, if it is determined at step 213 that the action is to perform a normal load leveling operation, then the power monitoring system 200 performs the normal load leveling operation process at step 214. The normal load leveling process is herein defined in further detail with regard to FIG. 9. After performing the normal load leveling operation process at step 214, the power monitoring system 200 returns to step 202 to wait for the next action.

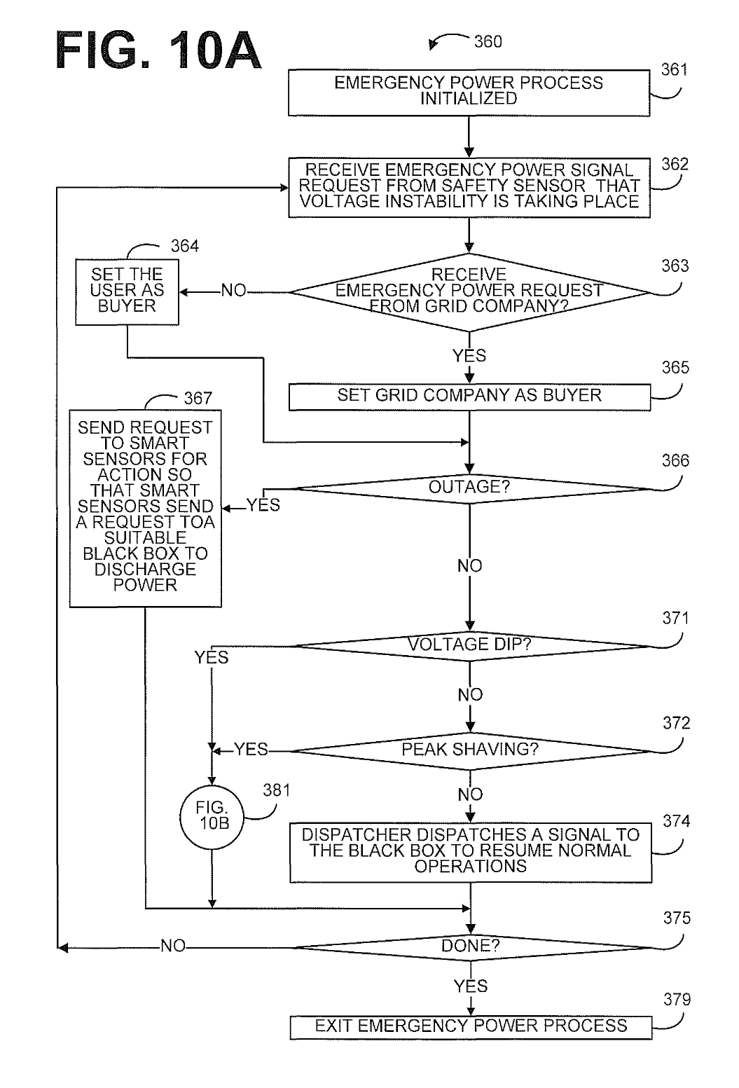

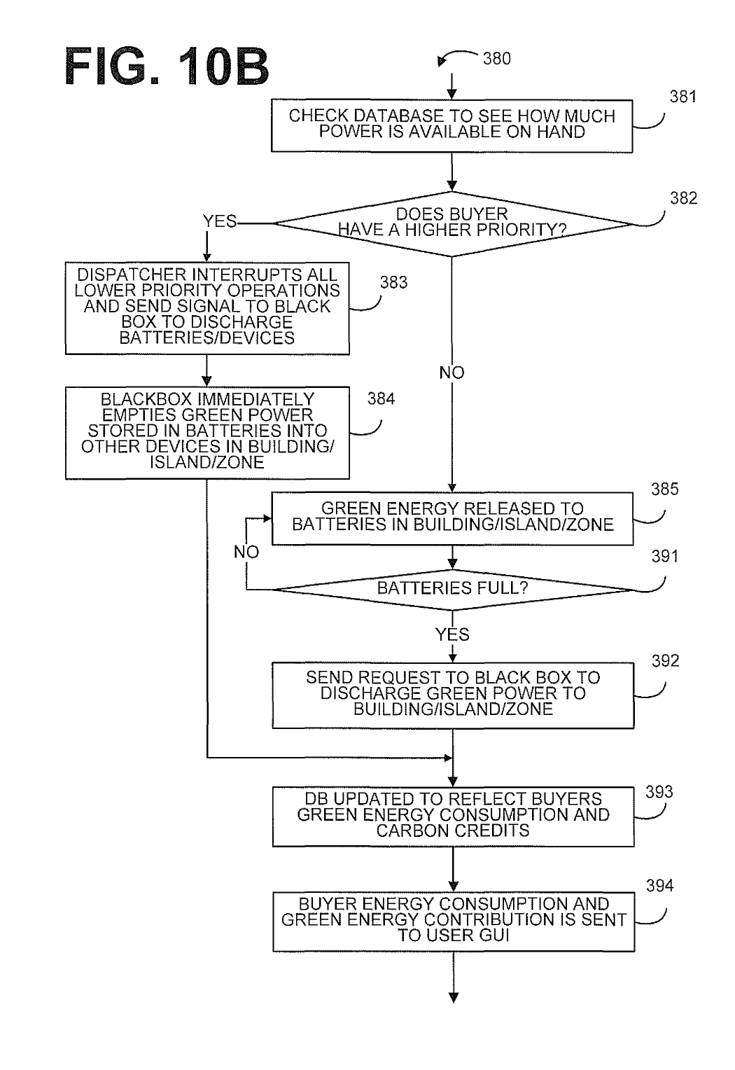

At step 215, it is determined if the action is to perform a the emergency power operation. It is determined at step 215 that the action is not to perform a emergency power operation, then the power monitoring system 200 proceeds to step 217. However, if it is determined at step 215 that the action is to perform a emergency power operation, then the power monitoring system 200 performs the emergency power operation process at step 216. The emergency power process is herein defined, in further detail with regard to FIGS. 10A-10B. After performing the emergency power operation process at step 212, the power monitoring system 200 returns to step 202 to wait for the next action.

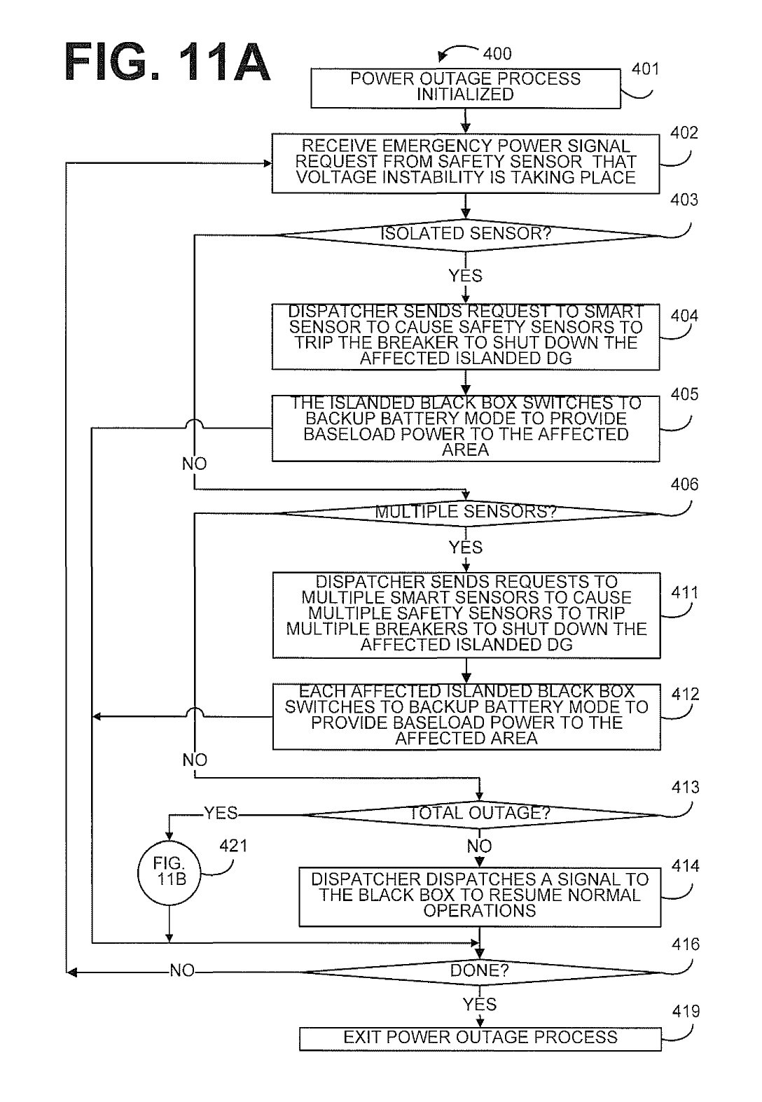

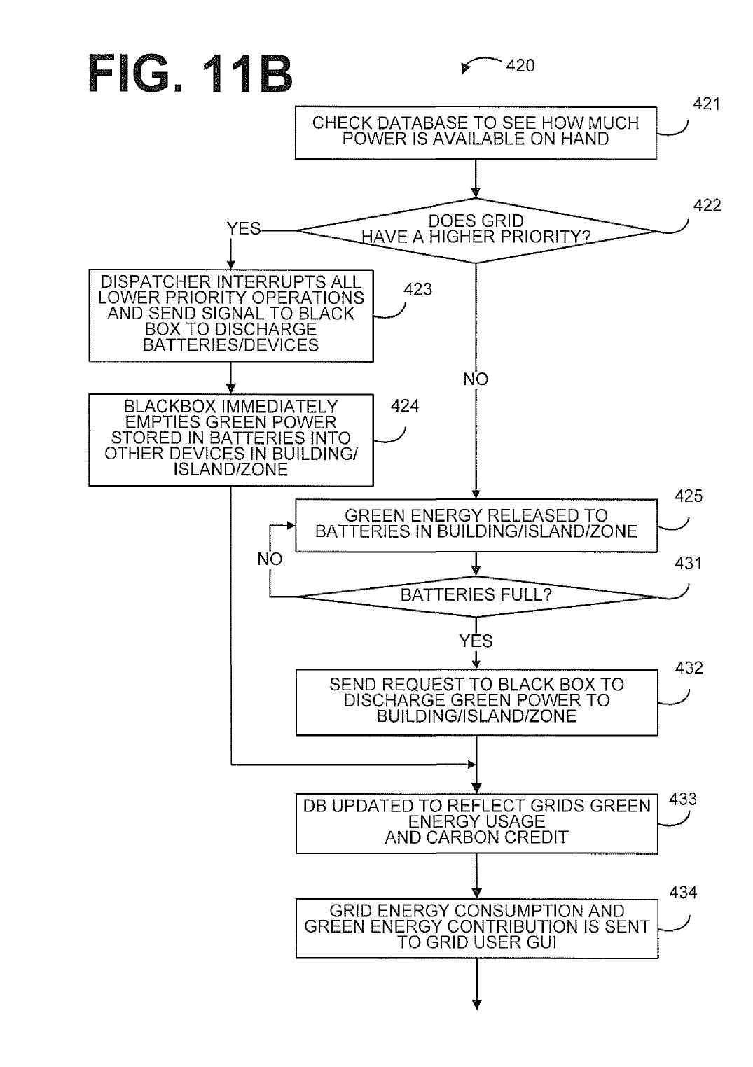

At step 217, it is determined if the action is to perform a power outage operation. It is determined at step 217 that the action is not to perform a power outage operation, then the power monitoring system 200 proceeds to step 221. However, if it is determined at step 217 that the action is to perform a power outage operation, then the power monitoring system 200 performs the power outage operation process at step 218. The normal load leveling process is herein defined in further detail with regard to FIGS. 11A-11B. After performing the power outage operation process at step 218, the power monitoring system 200 returns to step 202 to wait for the next action.

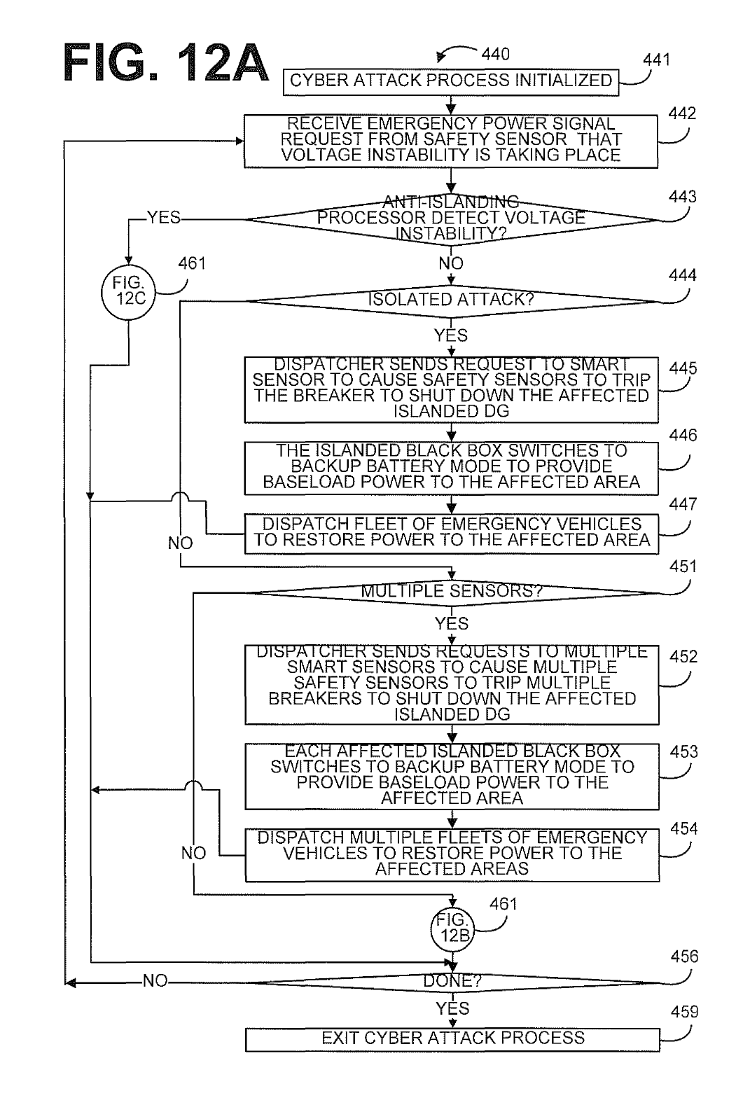

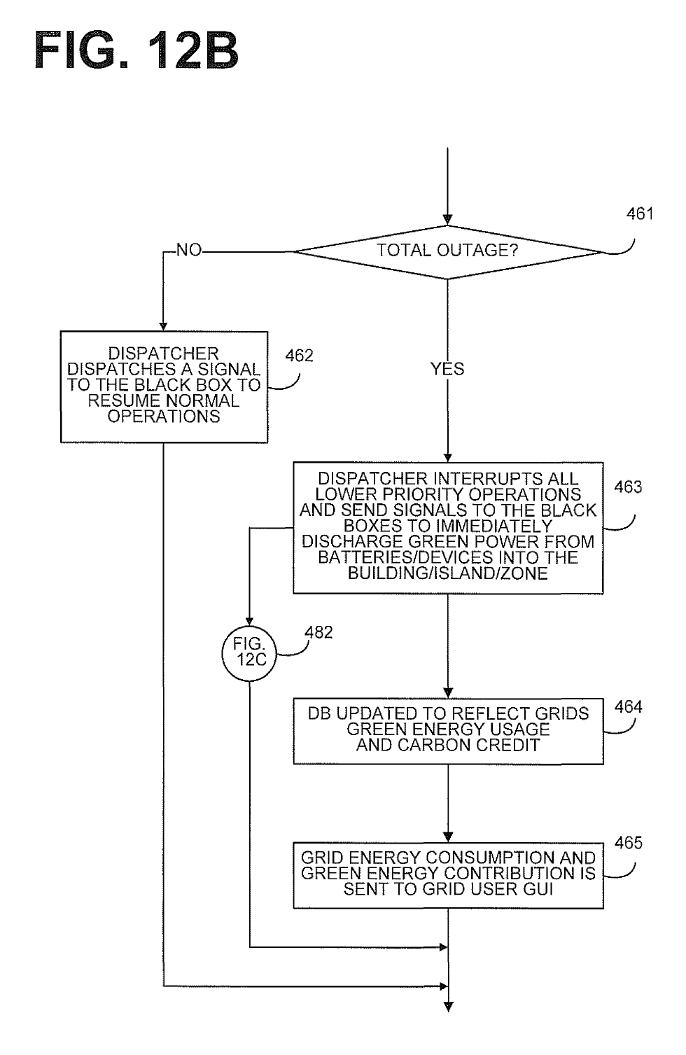

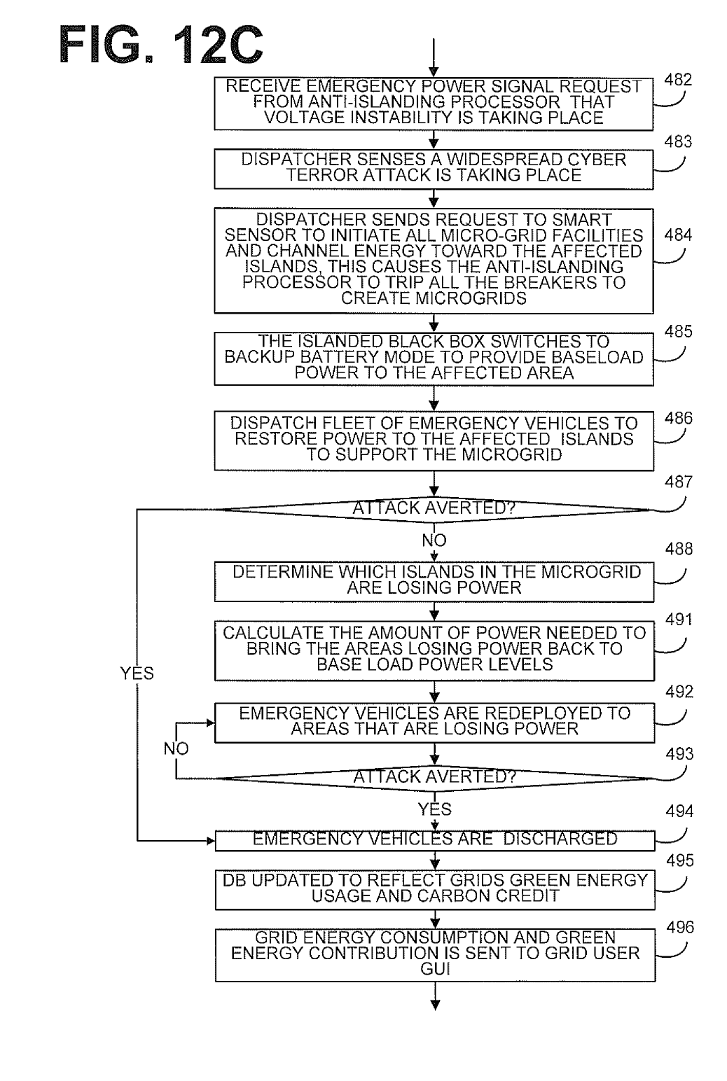

At step 221, it is determined if the action is to perform a cyber attack operation. It is determined at step 221 that the action is not to perform a cyber attack operation, then the power monitoring system 200 proceeds to step 223. However, if it is determined at step 221 that the action is to perform a cyber attack operation, then the power monitoring system 200 performs the cyber attack process at step 222 cyber attack. The normal load leveling process is herein defined in further detail with regard to FIGS. 12A-12C. After performing the cyber attack operation process at step 221, the power monitoring system 200 returns to step 202 to wait for the next action.

At step 223, it is determined if the power monitoring system 200 is to wait for additional actions. If it is determined at step 223 that the power monitoring system 200 is to wait for additional actions, then the power monitoring system 200 returns to repeat steps 202 through 223. However, if it is determined at step 223 that there are no more actions to be received, then the power monitoring system 200 exits at step 229.

FIG. 5 is a flow chart illustrating an example of the operation of the new customer process 240 utilized by the power monitoring system 200 of the present invention, as shown in FIGS. 2, 3A and 4. The new customer process 240 enables a user to sign up to join the democratized power network.

First at step 241, the new customer process 240 is initialized on server 20. This initialization includes the startup routines and processes embedded in the BIOS of the server 20. The initialization also includes the establishment of data values for particular data structures utilized in the power monitoring system 200.

At step 242, the new customer process 240 waits for a new user sign up to join the network. Once a new user indicates they wish to join the network, then the new customer process 240 determines which subscription level is chosen by the customer at step 243. In one embodiment, the different levels of subscription include, but are not limited to a free subscription, free plus, request, and restricted subscription level. The free subscription level enables a user to receive introductions and join discussion forums, send introductions and receive load shedding rebates. A free subscription level includes all of the privileges of the free level and further includes the ability to request peer-to-peer load shedding. A request level includes all of the privileges of the free plus and further includes be ability to receive virtual backup power from other users and a meta exchange network membership. The restricted level includes all of that of the request while level further include the ability to obtain open link bidirectional metering, priority customer service and accumulate and trade carbon credits.

At step 244, it is determined if the trunking and cabling is available for the level of support that the user chose. If it is determined at step 244 that the trunking and cabling requirements are available, then the new customer process proceeds to step 248. However, if it is determined in step 244 that the either the trunking or cabling is unavailable to the user for the level of support that the user has chosen, then the user is informed of the technician site visit is required because no infrastructure is available at step 245. At step 246, the new customer process 240 determines that the user has confirmed the appointment. If it user has confirmed the appointment, then the new customer process skips to step 251. However, if it is determined in step 246 that the user has not confirmed the appointment, then the new customer process 240 stores the cookie information in the database and makes a note to prompt the user of any future promotions, at step 247. After storing the cookie information in the database at step 247, and a new customer process 240 then skips to step 256.

At step 248, the device is connected to the black box and the software is activated for the new node.

At step 251, the new customer process finalizes a subscription details and confirmed the appointment date. At step 252, the new customer process 240 determines if the user agrees on the subscription rate and power allocation. If it is determined at step 252 that the user does not agree to these subscription rate or allocation, then the new customer process 240 skips the step 255. However, if it is determined in step 252 that the user does agree to the subscription rate and allocation, then the user pays for the shopping cart items and sets up the billing at step 253. In one embodiment, the shopping cart items are purchased utilizing in the electronic transactions such as a credit card or online banking. However it is contemplated by the inventors that other types of payment plans can be utilized. At step 254, the database is updated to reflect the new member backup information. The new customer process 240 then skips to step 256.

At step 255, the shopping card information is stored in a database for later retrieval.

At step 256, it is determined if the new customer process 240 is to wait for additional actions. If it is determined at step 256 that the new customer process 240 is to wait for additional actions, then the new customer process 240 returns to repeat steps 242 through 256. However, if it is determined at step 256 that there are no more actions to be received, then the new customer process 240 exits at step 259.

FIG. 6 is a flow chart illustrating an example of the operation of the premium subscription process 260 utilized by the power monitoring system 200 of the present invention, as shown in FIGS. 2, 3A and 4. The premium subscription process 260 enables a user to subscribe to premium services that include requesting from and providing virtual backup power to other members.

First at step 261, the premium subscription process 260 is initialized on server 20. This initialization includes the startup routines and processes embedded in the BIOS of the server 20. The initialization also includes the establishment of data values for particular data structures utilized in the power monitoring system 200.

At step 262, the premium subscription process 260 waits for a user to request virtual backup power. Once it is determined that a user has requested packet power, and it is determined at step 263, if the users zone as the infrastructure available to supply secure backup power. At step 264, it is determined if backup power is available. If it is determined that backup power is available, then the premium subscription process 260 skips to step 268.

However, if it is determined at step 264 that no backup power is available, then the user is informed of that no excess power is available at step 265. At step 266, it is the determined if the user wishes to trade power with other users. If it is determined at step 266 be user does wish to trade power with other users, then the premium subscription process 260 skips to step 271. However, if it is determined at step 266 at the user does not wish to trade power with other users, then the premium subscription process 260 stores the cookie information and prompts a database to notify the member of any future promotions at step 267. After storing the information in the database 21, then the premium subscription process 260 skips to step 276.

At step 268, the quantity of backup power available to the user and the price of that power is determined.

At step 271, the trading price and allocated energy information are set to the user's digital dashboard or GUI. The premium subscription process 260 then determines if the user agrees on the price and allocation at step 272. If it is determined in step 272, that the user does not agree, then the premium subscription process skips to step 275. However, if it is determined that the user does agree on price and allocation, then the user pays for the shopping cart items and sets up the billing at step 273. In one embodiment, the shopping cart items are purchased utilizing in the electronic transactions such as a credit card or online banking. However it is contemplated by the inventors that other types of payment plans can be utilized. At step 274, the database is updated to reflect the new member backup power information. The premium subscription process 260 then skips to step 276.

At step 275, the shopping card information is stored in a database for later retrieval.

At step 276, it is determined if the premium subscription process 260 is to wait for additional actions. If it is determined at step 276 that the premium subscription process 260 is to wait for additional actions, then the premium subscription process 260 returns to repeat steps 262 through 276. However, if it is determined at step 276 that there are no more actions to be received, then the premium subscription process 260 exits at step 279.

FIG. 7 is a flow chart illustrating an example of the operation of the normal operations process 280 utilized by the power monitoring system 200 of the present invention, as shown in FIGS. 2, 3A, and 4. The normal operations process DVD provides a grid tie with green electrons.

First at step 281, the normal operations process 280 is initialized on server 20. This initialization includes the startup routines and processes embedded in the BIOS of the server 20. The initialization also includes the establishment of data values for particular data structures utilized in the power monitoring system 200.

At step 282, the normal operations process 280 polls the database 21 to determine if any device needs to be activated. At step 283 it is determined if a device needs to be activated. If it is determined at step 283 that it device does not to be activated, then the normal operations process 280 update the inactivity status in the users digital dashboard or GUI at step 284 and then returns to step 282 for the next active poll.

However, if it is determined at step 283 that of device does need to be activated, then the normal operations process 280 sends a signal to the black box initiating the transfer of energy to the grid at step 285. At step 286, the database and user digital dashboard/GUI are updated with the real time power status.

At step 287, it is determined if the member requires green electrons. If determined at step 287 that the member does not need green electrons, then be normal operations process 280 then skips to step 292. However, if it is determined that the member does need green electrons, then normal operations process 280 determines which notes require a transfer of green electrons at step 288. At step 289, normal operations process 280 sends a request to the black box to discharge green power to distribute into the members unit. At step 290, the database is updated to reflect the users carbon credits. At step 291, the spot trading price and individual carbon credits are sent to the user's digital dashboard/GUI for display. Normal operations process 280 then skips to step 298.

At step 292, the green energy is stored in batteries and the extra energy is released to other devices in the building, island or zone. At step 293, the green energy is released and discharged into batteries within the building, island or zone. At step 294, it is determined if the batteries are full. It is determined in step 294 that the batteries are not full, then the normal operations process 280 returns to repeat step 293. However, if it is determined in step 294 that that the batteries are full, then the normal operations process 280 sends a request to the black box to just charge green power to the building, island or zone at step 295. In step 296, the database is updated to reflect the building, island, or zone carbon credits and the total green energy usage. At step 397, the spot trading price and total combined carbon credits are set to the users digital dashboard/GUI for display.

At step 298, it is determined if the normal operations process 280 is to wait for additional actions. If it is determined at step 298 that the normal operations process 280 is to wait for additional actions, then the normal operations process 280 returns to repeat steps 282 through 298. However, if it is determined, at step 298 that there are no more actions to be received, then the normal operations process 280 exits at step 299.

FIG. 8 is a flow chart illustrating an example of the operation of the normal green operation process 300 utilized by the power monitoring system 200 of the present invention, as shown in FIGS. 2, 3A and 4.

First at step 301, the normal green operation process 300 is initialized on server 20. This initialization includes the startup routines and processes embedded in the BIOS of the server 20. The initialization also includes the establishment of data values for particular data structures utilized in the power monitoring system 200.

At step 302, the normal green operation process 300 polls the database 21 to determine if any device needs to be activated. At step 303, it is determined if a device needs to be activated. If it is determined at step 303 that it device does not to be activated, then the normal green operation process 300 update the inactivity status in the users digital dashboard or GUI at step 304 and then returns to step 302 for the next active poll.

However, if it is determined at step 303 that of device does need to be activated, then the normal green operation process 300 sends a signal to the black box initiating the transfer of energy to the grid at step 305. At step 306, the database and user digital dashboard/GUI are updated with the real time power status.

At step 307, it is determined if the member requires green electrons. If it is determined at step 307 that the member does not need green electrons, then be normal green operation process 300 then skips to step 312. However, if it is determined that the member does need green electrons, then normal green operation process 300 sends a request to the black box to discharge green power to distribute into the members unit, at step 308. At step 309, the database is updated to reflect the user's carbon credits. At step 311, the spot trading price and individual carbon credits are sent to the user's digital dashboard/GUI for display. Normal green operation process 300 then skips to step 318.

At step 312, the green energy is stored in batteries and the extra energy is released to other devices in the building, island or zone. At step 313, the green energy is released and discharged into batteries within the building, island or zone. At step 314, it is determined if the batteries are full. It is determined in step 314 that the batteries are not pull, then the normal green operation process 300 returns to repeat step 313. However, if it is determined in step 314 that that the batteries are full, then the normal green operation process 300 sends a request to the black box to just charge green power to the building, island or zone at step 315. In step 316, the database is updated to reflect the building, island, or zone carbon credits and the total green energy usage. At step 397, the spot trading price and total combined carbon credits are set to the user's digital dashboard/GUI for display.

At step 318, it is determined if the normal green operation process 300 is to wait for additional actions. If it is determined at step 318 that the normal green operation process 300 is to wait for additional actions, then the normal green operation process 300 returns to repeat steps 302 through 318. However, if it is determined at step 318 that there are no more actions to be received, then the normal green operation process 300 exits at step 319.

FIG. 9A-B are a flow chart illustrating an example of the operation of the normal load leveling process 320 utilized by the power monitoring system 200 of the present invention, as shown in FIGS. 2, 3A and 4. The meta-exchange system 100 can broadcast an email/text message invitation to one or more communication devices 22, and the user of each communication device can either accept or reject the invitation either in real time or in a delayed mode. If the energy request is accepted by one of the user communication devices 22, then the controller/dispatcher initiates the transfer of requested energy from the accepting user communication device 22 to the power grid 14

First at step 321, the normal load leveling process 320 is initialized on server 20. This initialization includes the startup routines and processes embedded in the BIOS of the server 20. The initialization also includes the establishment of data values for particular data structures utilized in the power monitoring system 200.

At step 322, the normal load leveling process 320 waits for a good company sign into database 21. The system to check to see if the grid company is a new member at step 323. If it is determined at step 323 that the grid Company is not a new member, then the normal load leveling process 320 uses a database to pull up the grid companies record and list of services that they had subscribe to at step 324 and then skips to step 327.

However, it is determined at step 323 to the grid company is a new member, then the normal load leveling process 320 inquires if the grid company wants to subscribe to the services or if this is just a one-time event at step 325. At step 326, it is determined if the grid company is making a one-time request. If it is determined that the grid company is making a one-time request, then the normal load leveling process 320 skips to step 341 (FIG. 9B). However, if it is determined at step 326, that the grid company is not making a one-time request, then the normal load leveling process 320 sends data to the grid company's digital dashboard/GUI to show services available.

At step 331, the normal load leveling process 320 determines if the grid member added items to a shopping cart. If it is determined at step 331 that grid member did not add items to the shopping cart, then the normal load leveling process 320 skips to step 337. However, if it is determined at step 331 at the member grid did add items to the shopping cart, then a using the digital dashboard/GUI screen menu prompts the grid company to proceed to checkout at step 332.

At step 333, is determined if the grid member it is ready to check out and pay for items. If it is determined, at step 333 that the grid member is not ready to checkout, then the normal load leveling process 320 then skips to step 336. However, if it is determined in step 333 that the grid member is ready to checkout and pay for items, then the total cost is calculated and presented for payment at step 334. In one embodiment, the e-commerce method of payment is via credit card or electronic-payment. However, that is, contemplated by the inventors that other types of payments are possible. At step 335, the debate database is updated to reflect the updated service for the new member if this grid member is a new member. The normal load leveling process 320 then skips to step 337.

At step 336, the database stores the grid company info and database check out for data mining and future usage.

At step 337, it is determined if the normal load leveling process 320 is to wait for additional actions. If it is determined at step 337 that the normal load leveling process 320 is to wait for additional actions, then the normal load leveling process 320 returns to repeat steps 322 through 338. However, if it is determined at step 337 that there are no more actions to be received, then the normal green operation process 300 exits at step 339.

At step 341, the normal load operation process checks the database 21 to determine if spare power capacity is available. If it is determined in step 342 that capacity not available, then a message is sent to the grid company notifying them that no capacity is currently available at step 343 and then returns to step 337.

However, if it is determined at step 342 that capacity is available, then the grid company is sent information for display on his GUI that shows a capacity available and the duration, at step 344. At step 345, it is determined if the grid company has added items into a shopping cart. If it is determined at step 345 that the grid, company has not added items to the shopping cart, then the normal load leveling process 320 skips to step 354.

However, if it is determined at step 345 that the grid company member has added items to the shopping cart, then the normal load leveling process 320 uses a screen menu prompt for the grid company to proceed to checkout at step 346. At step 351, it is determined if the member wants to checkout and pay for the items. If it is determined that the member is ready to checkout, then the total cost are calculated and the payment process is initiated. In one embodiment the payment process is performed by utilizing a credit card or E. payment. However, it is contemplated by the inventors that other types of payment methods may be utilized. At step 353, the database is updated to reflect the updated service and the new member if this is a new member and then returns to step 337.

At step 354, the normal load leveling process 320 stores in a database the grid company information for data mining and future usage and then returns to step 337. That future usage includes but is not limited to promotions, invitations to join me meta-exchange network membership and the like.

FIG. 10A-B are a flow chart illustrating an example of the operation of the emergency power process 360 utilized by the power monitoring system 200 of the present invention, as shown in FIGS. 2, 3A and 4. The emergency power process 360 enables a grid company or a user individual to subscribe to emergency power from the renewable energy devices 18A-18N. The platform will switch to the emergency power if the voltage drops suddenly and discharges all of the available accumulated energy and the system within this zone, island or building experiencing the voltage drop until the system is stabilized. This can be a user function or a grid company can explicitly request emergency power.

First at step 321, the emergency power process 360 is initialized on server 20. This initialization includes the startup routines and, processes embedded in the BIOS of the server 20. The initialization also includes the establishment of data values for particular data structures utilized in the power monitoring system 200.

At step 362, the emergency power process 360 waits to receive an emergency power signal request from a safety sensor that voltage instability is taking place. After receiving such signal, there is then a test to see if the emergency power process 360 has received an emergency power request from a grid company at step 363. If the grid company has made an emergency power request, then the emergency power process 360 proceeds to step 365. However, if it is determined that the grid company has not made an emergency power request, then the emergency power process 360 the user as the buyer at step 364 and skips to step 366. At step 365, the emergency power process 360 sets the grid company as the buyer.

At step 366, the emergency power process 360 determines if there is an outage on the power grid 14. If it is determined that there is an outage on the power grid 14, then the emergency power process 360 sends a request to the smart sensors are actions are that the smart sensors send a request to a suitable black box to discharge power. The emergency power process 360 then proceeds to step 375.

However, if it is determined in step 366 that outage did not occur, then the emergency power process 360 determines if there's been a voltage dips at step 371. It is determined at step 371 that there had been a voltage dip, then the emergency power process 360 proceeds to step 381 in FIG. 10B. However, if it is determined at step 371 the voltage dips has not occur, then the emergency power process 360 determines if peak power shaving has occurred its at step 372. If it is determined at step 372 if peak shaving has occurred, then the emergency power process 360 proceeds to step 381. However, if it is determined that peak power shaving has not occurred, then the dispatcher dispatch is a signal to the black box to resume normal operation at step 374 and then proceed to step 375.

At step 381, the emergency power process 360 checks the database to see how much power is available on hand. At step 382, the emergency power process 360 determines if the buyer has a higher priority than the other members. In this way, we can determine if it is the grid company who is requesting emergency power as a buyer or if it is a user who is attempting to buy additional power.

If it is determined at step 382 if the buyer does not have higher priority, then the emergency power process 360 skips to step 385. However, if it is determined in step 382 that the buyer does have higher priority than the other members, then the dispatcher interrupts all lower priority operations and sends a signal to black boxes to discharge their batteries into other devices in the building, island or zone at step 383. At step 384, the black box is immediately empty green power stored in batteries into the other devices in the building, island, or zone, and then proceed to step 393.

At step 385, the green energy is released to batteries in the building, island or zone. At step 391, the emergency power process 360 then determines if the batteries are full. If it is determined at step 391 that the batteries are not full, then the emergency power process 360 returns to repeat step 385. However, if it is determined at step 391 that the batteries are full, then the emergency power process sends a request to black boxes to discharged green power into the building, island or zone at step 392.

At step 393, the database is updated to reflect the buyers green energy consumption and carbon credits. At step 394, the buyer energy consumption and green energy contribution is sent for display on the users digital dashboard/GUI, and then returns to step 375.

At step 375, it is determined if the emergency power process 360 is to wait for additional actions. If it is determined at step 375 that the emergency power process 360 is to wait for additional actions, then the emergency power process 360 returns to repeat steps 372 through 375. However, if it is determined at step 375 that there are no more actions to be received, then the emergency power process 360 exits at step 379.

FIG. 11A-B are a flow chart illustrating an example of the operation of the power outage process 400 utilized by the power monitoring system 200 of the present invention, as shown in FIGS. 2, 3A and 4. The power monitoring system 200 will jettison a part of the attack the community area if there is an isolated fault within the area until the system is up and running. Say for example a tree to power line, a car hit a utility pole and the light. That way the help of channel backup or grid power is supplied to other parts of the grid to restore the based load power.

First at step 401, the power outage process 400 is initialized on server 20. This initialization includes the startup routines and processes embedded in the BIOS of the server 20. The initialization also includes the establishment of data values for particular data structures utilized in the power monitoring system 200.

At step 402, the power outage process 400 waits to receive an emergency power signal request from a safety sensors that a voltage instability is taking place. Once the emergency power signal request is received, the power outage process 400 determines at step 403 if it is an emergency power signal request from an isolated sensor. If it is determined in step 403 that the request is not from an isolated sensor, then a power outage process 400 proceeds to step 406. However, if it is determined at step 403 that the emergency power signal request is from an isolated sensor, then the power outage process 400 dispatches a request to smart sensors to cause safety sensors to trip the breaker to shut down the affected island distributed generation. At step 405, the island blackbox switches to battery backup mode to provide based load power to the affected area. The power outage process 400 then proceeds to step 416.

At step 406, the power outage process 400 determines if it is an emergency power signal request from a multitude of sensors. If it is determined in step 406 that the request is not from a multitude of sensors, then a power outage process 400 proceeds to step 413. However, if it is determined at step 406 that the emergency power signal request is from a multitude of sensors, then the power outage process 400 dispatches a request to a multitude of smart sensors to cause safety sensors to trip multiple breakers to shut down the affected island distributed generation at step 411. At step 412, each affected island blackbox switches to battery backup mode to provide based load power to the affected area. The power outage process 400 then proceeds to step 416.

At step 413, it is determined if a total power outage is being experienced. If it determined at step 413 that a total power outage has occurred has occurred, then the power outage process 400 proceeds to step 421. However, if it is determined that peak total power outage has not occurred, then the dispatcher dispatch is a signal to the black box to resume normal operation at step 414 and then proceed to step 416.

At step 421, the power outage process 400 checks the database to see how much power is available on hand. At step 422, the power outage process 400 determines if the grid has a higher priority than the other members. If it is determined at step 422 that the grid does not have higher priority, then the power outage process 400 skips to step 425. However, if it is determined in step 422 that the grid does have higher priority than the other members, then the dispatcher interrupts all lower priority operations and sends a signal to black boxes to discharge their batteries into other devices in the building, island or zone at step 423. At step 424, the black box is immediately empty green power stored in batteries into the other devices in the building, island, or zone, and then proceed to step 433.

At step 425, the green energy is released to batteries in the building, island or zone. At step 431, the power outage process 400 then determines if the batteries are full. If it is determined at step 431 that the batteries are not full, then the power outage process 400 returns to repeat step 425. However, if it is determined at step 431 that the batteries are full, then the emergency power process sends a request to black boxes to discharged green power into the building, island or zone at step 432.

At step 433, the database is updated to reflect the buyers green energy consumption and carbon credits. At step 434, the buyer energy consumption and green energy contribution is sent for display on the users digital dashboard/GUI, and then returns to step 415.

At step 415, it is determined if the power outage process 400 is to wait for additional actions. If it is determined at step 415 that the power outage process 400 is to wait for additional actions, then the power outage process 400 returns to repeat steps 412 through 415. However, if it is determined at step 415 that there are no more actions to be received, then the power outage process 400 exits at step 419.

FIG. 12A-C are a flow chart illustrating an example of the operation of the cyber attack process 440 utilized by the power monitoring system of the present invention, as shown in FIGS. 2, 3A and 4. The power monitoring system 200 will also switch to a mode where virtual power will be the dispatched, so that, to the end user it closely resembles the grid. This can be a two-step process where a base load power is released first to conserve energy, and then a fleet of emergency vehicles will arrive later to restore full power until the grid is repaired in back online again. When a grid is under total cyber terrorist attack (such as via a “fast algorithm”), it can break off and fragment into many parts that are self-generating or autonomous microislands via a suitable intelligent screening and pattern extraction method and be supplemented by external mobile generators if and whenever there a threat or risk of cyber terrorism.

First at step 441, the cyber attack process 440 is initialized on server 20. This initialization includes the startup routines and processes embedded in the BIOS of the server 20. The initialization also includes the establishment of data values for particular data structures utilized in the power monitoring system 200.

At step 442, the cyber attack process 440 waits to receive an emergency power signal request from a safety sensors that a voltage instability is taking place. Once the emergency power signal request is received, the cyber attack process 440 determines at step 443 if it is an emergency power signal request from an anti-islanding processor that detected the voltage instability. If it is determined in step 443 that the request is not from an anti-islanding processor, then a cyber attack process 440 proceeds to step 451. However, if it is determined at step 443 that the emergency power signal request is from an anti-islanding processor, then the cyber attack process 440 dispatches a request to smart sensors to cause safety sensors to trip the breaker to shut down the affected island distributed generation at step 445. At step 446, the island blackbox switches to battery backup mode to provide based load power to the affected area. At step 447, the cyber attack process 440 dispatches a fleet of an emergency vehicles to restore power to the affected area and then proceeds to step 456.

At step 451, the cyber attack process 440 determines if it is an emergency power signal request from a multitude of sensors. If it is determined in step 451 that the request is not from a multitude of sensors, then a cyber attack process 440 proceeds to step 461. However, if it is determined at step 451 that the emergency power signal request is from a multitude of sensors, then the cyber attack process 440 dispatches a request to a multitude of smart sensors to cause safety sensors to trip multiple breakers to shut down the affected island distributed generation at step 452. At step 453, each affected island blackbox switches to battery backup mode to provide based load power to the affected area. At step 447, the cyber attack process 440 dispatches multiple fleets of emergency vehicles to restore power to the affected area and then proceeds to step 456.

At step 461, it is determined if a total power outage is being experienced. If it is determined at step 461 that a total power outage has occurred has occurred, then the cyber attack process 440 proceeds to step 463. However, if it is determined that peak total power outage has not occurred, then the dispatcher dispatch is a signal to the black box to resume normal operation at step 462 and then proceed to step 456.

At step 463, the cyber attack process 440 the dispatcher interrupts all lower priority operations and sends a signal to black boxes to discharge their batteries into other devices in the building, island or zone. After performing step 463, the cyber attack process performs steps 482 and 464. At step 464, the database is updated to reflect the grid green energy consumption and carbon credits. At step 465, the grids green energy consumption and green energy contribution is sent for display on the grids digital dashboard/GUI, and then returns to step 456.

At step 482, the cyber attack process 440 receives an emergency power signal request from anti-islanding processor that voltage instability is taking place. At step 483, the dispatch since is a widespread cyber terror attack on the grid is taking place. The dispatch then sends a request to all smart sensors to initiate all micro-grid facilities and channel energy toward the affected islands at step 484. This causes the anti-islanding processor to trip all the breakers to create microgrid.

At step 485, all island blackbox switch to battery backup mode to provide based load power to the affected area. At step 486, the cyber attack process 440 dispatches multiple fleets of emergency vehicles to restore power to the affected areas.

At step 487, the cyber attack process 440 determines if the attack has been averted. If it is determined that the cyber attack has been averted, then the cyber attack process 440 proceeds to step 494. However, if it is determined that the attack has not been averted, then it is determined which islands in the microgrid are losing power at step 488. At step 491, there is a calculation of the amount of power needed to bring the area's losing power back to the base load power levels. At step 492, emergency vehicles are redeployed to the areas that are losing power.

At step 493, it is determined whether or not the cyber attack has been averted. If it is determined at step 493 that the cyber attack has not been averted, then the cyber attack process 440 returns to repeat step 492 to redeploy emergency vehicles to those areas that are losing power.

At step 494, the emergency vehicles are discharged after a determination that the attack is averted. At step 495, the database is updated to reflect the grid green energy consumption and carbon credits. At step 496, the grids green energy consumption and green energy contribution is sent for display on the grids digital dashboard/GUI, and then proceeds to step 456.

At step 456, it is determined if the cyber attack process 440 is to wait for additional actions. If it is determined at step 456 that the cyber attack process 440 is to wait for additional actions, then the cyber attack process 440 returns to repeat steps 441 through 456. However, if it is determined at step 456 that there are no more actions to be received, then the cyber attack process 440 exits at step 459.

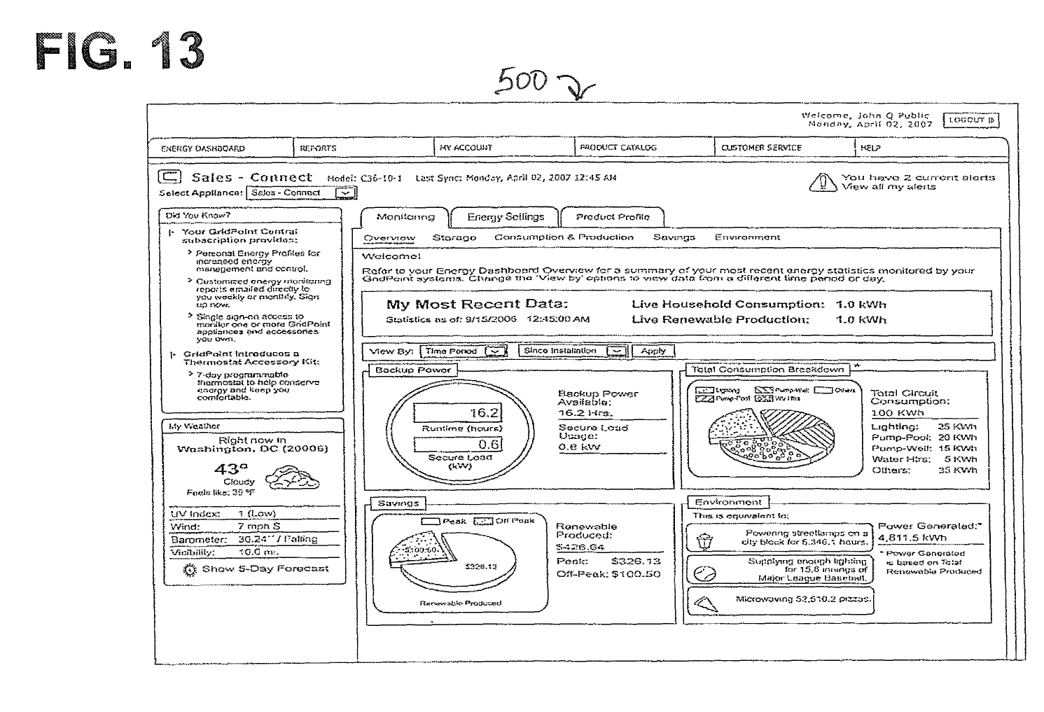

FIG. 13 is a schematic diagram illustrating an example of a digital dashboard utilized by the power monitoring system of the present invention, as shown in FIGS. 2, 3A and 4. The digital dashboard 500 can have the ability to price signal via the meta-exchange system 100 through mobile, PLC, wireless, and RF means using a location specific energy pricing algorithm, and the member can make the final decision as to whether to accept these price signals by hitting the accept button and docking via a suitable docking station or through inductive plates that are attached to the vehicle's undercarriage to discharge his power.

Preferably, each user has an individual account with predetermined privileges. Depending on the user's privileges, the website of the digital dashboard 500 can be configured to provide the user the ability to buy or sell energy—or secure premium/backup power, such as on an as-needed basis. Additionally, the website of the digital dashboard 500 can be configured to display to the user a visual representation of the amount of energy stored in the user's one or more renewable energy devices 18 such as shown in FIG. 13. Moreover, the website of the digital dashboard 500 can be configured to display a visual representation of the amount of energy and price that was bought and sold in past, other user's power availability and capacity, the amount of carbon credits the user currently has, etc. Moreover, the website can provide additional P2P communications so that the users can communicate with one another. Furthermore, the website can be configured to allow the user to adjust his communication equipment, duration, chat and email feed characteristics, etc. Therefore, the meta exchange acts as a central clearing house for the Meta Grid.

In a typical embodiment, a web 2.0 (or better) software and database architecture stores members' information and provide a common platform for users to communicate and trade power with one another. The web 2.0 (or better) website also serves as a vehicle for discussions, equipment trading, and as a digital dashboard 500 to broadcast and update users on power availability and pricing details. Each user has his/her own membership account that provides them with different levels of privileges and hardware according to their subscription plan. Within the different levels of access, the members can view various statistics, including historical prices of transactions, their own power availability and capacity and any carbon credits that he is entitled to. Depending on the level of subscription, the members can also be privileged to view different screens where the user can make decisions including the frequency and means of price signaling and to which mobile devices view and select different demand management options and make several options during an emergency situation.

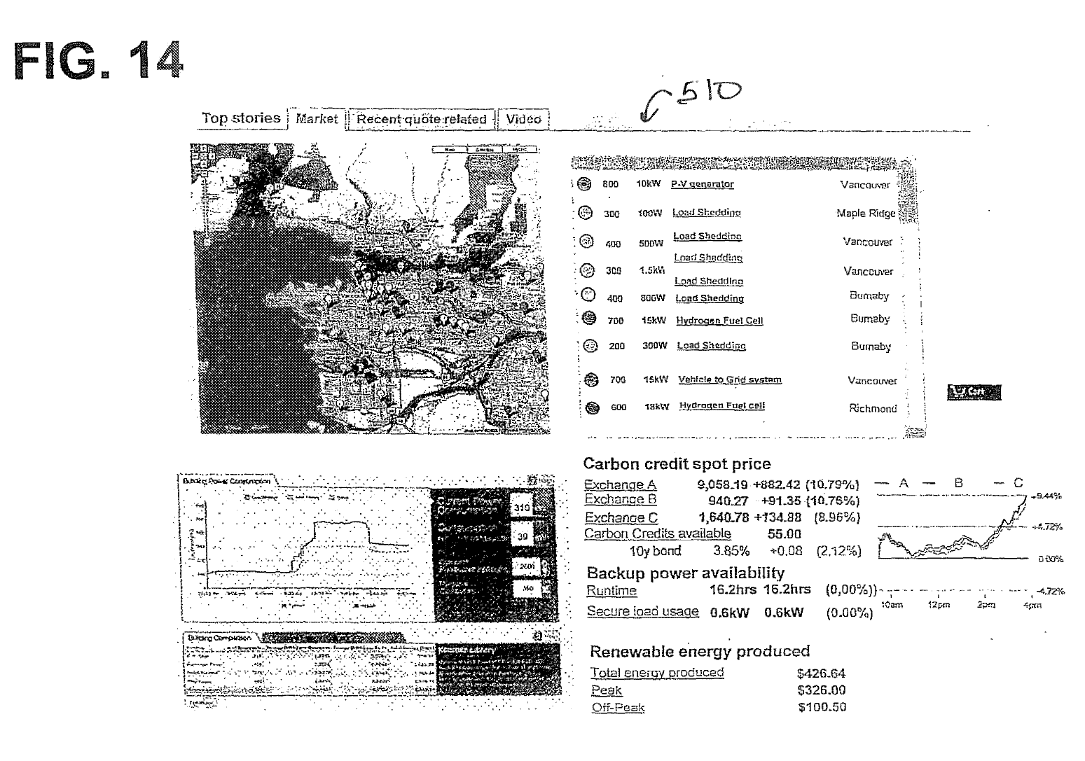

FIG. 14 is a schematic diagram illustrating an example of a digital dashboard map 510 utilized by the power monitoring system of the present invention, as shown in FIGS. 2, 3A and 4. The website of the digital dashboard 500 can further be configured to show a digital dashboard map 510 (such as a GOOGLE® map) showing other users of the system in the community (see FIG. 14).

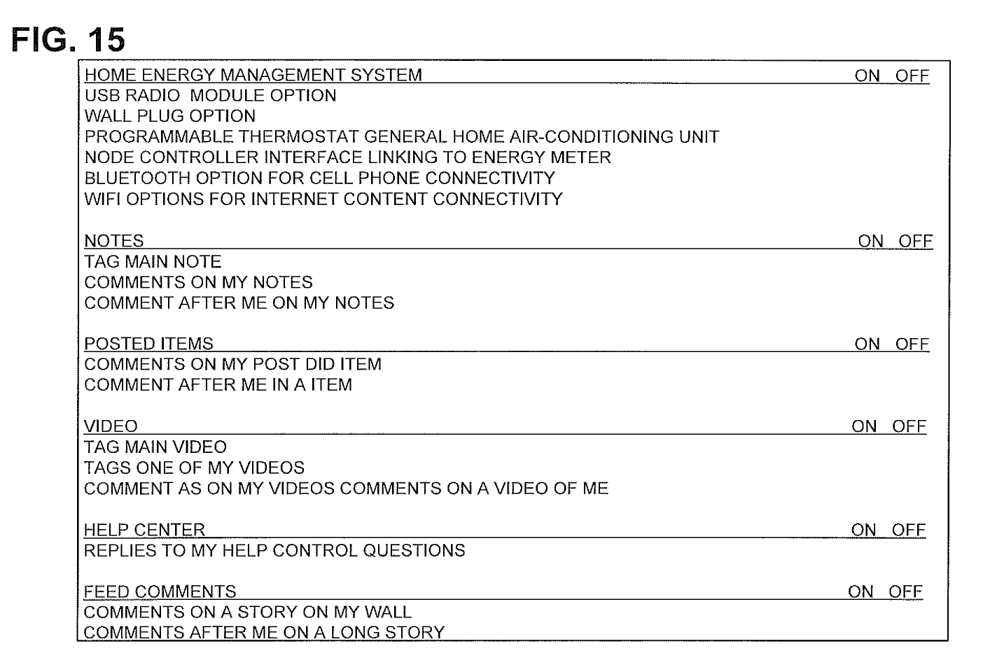

FIG. 15 is a schematic diagram illustrating an example of a digital dashboard adjustments utilized by the power monitoring system of the present invention, as shown in FIGS. 2, 3A and 4. The digital dashboard adjustments website can be configured to allow the user to adjust his communication equipment, duration, chat and email feed characteristics, etc (See FIG. 15). As such, this system of the present invention allows users/customers to take an active part in deciding how and when to use power and from what sources. Additionally, the users/customers can participate in ancillary services and transmission level support, as well as influence distribution options.

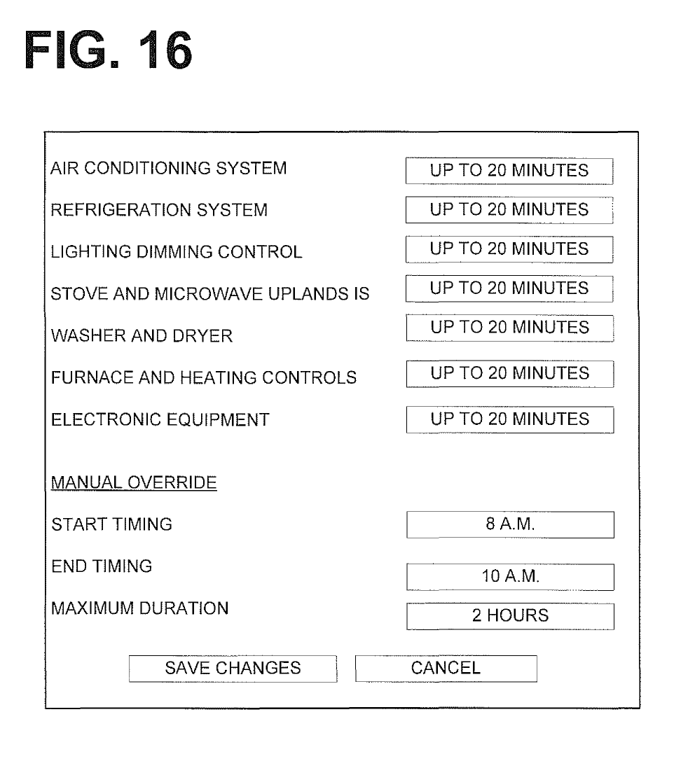

FIG. 16 is a schematic diagram illustrating an example of a digital dashboard 500 preferences utilized by the power monitoring system of the present invention, as shown in FIGS. 2, 3A and 4.

In the illustrated example, the user can input his preferences. Thus, the website for the digital dashboard 500 is configured to allow the user to adjust his individual equipment on/off timings and manually override some features. However, such changes by the user may come with a penalty. For example, the system can be set to warn the user that by overriding any of the predetermined load shedding algorithms, the user forfeits his discount (or a portion thereof). If the user were to try to tamper with the black box and/or the system, the controller can sense such irregularities and intrusion and inform the system 10 to penalize the user (such as by withholding its discount and/or charging a penalty fee). Additionally or alternatively, the black box and the website can be configured to provide some flexibility to override certain algorithms in situations where the device at issue is non-critical and does not carry a huge load.

The preferences can include which devices can be shut off and for how long. For example, the user may select options in a pull-down menu that set preferences as follows: turn air conditioner off for no more than 8 hours, turn refrigerator off for no more than 2 hours, etc. Thus, in the event of an emergency, the meta-exchange sends a signal to power down one or more user devices (as predetermined and stored in the user preferences) and then sends a subsequent signal after the predetermined duration has lapsed so as to activate the powered off device(s). If for some reason, the system does not send the subsequent signal, then the system can be penalized, such as in the form of paying fees to the user(s) or a premium for the power consumed. The preferences and manner of inputting such preferences (i.e., one or more pull-down menus) illustrated herein are merely examples, and all other appropriate preferences manners of input are within the scope of this invention. Thus, the system is a democratic system with the system/grid and members on “equal footing.”

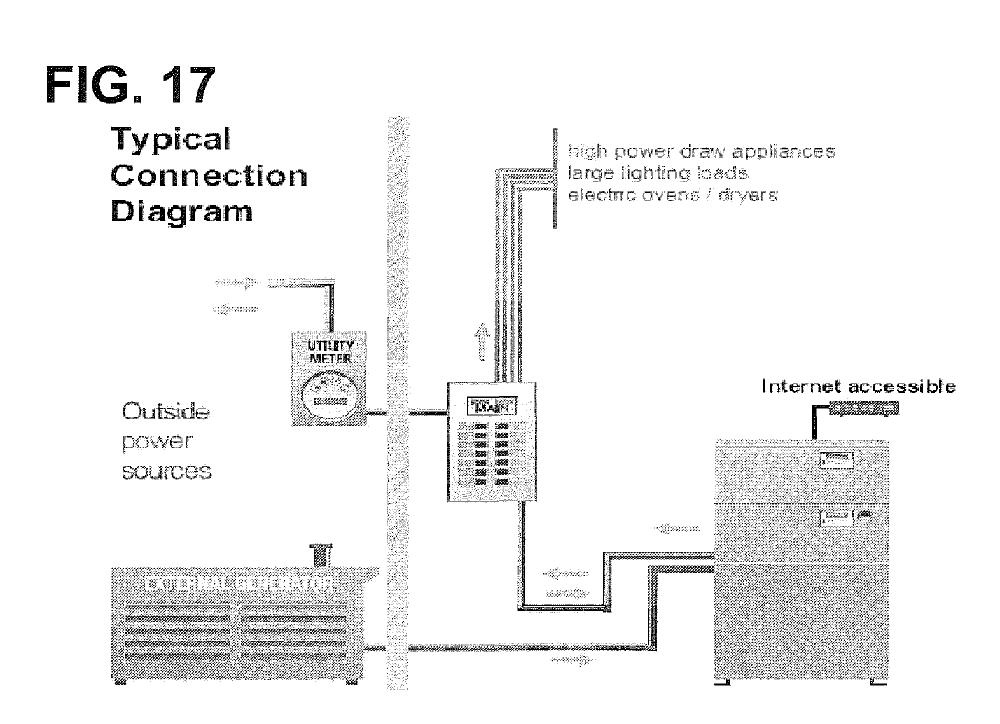

Additionally users of the free plus world 192 can receive greater incentives profits) by allowing the black box unit to receive ad hoc signals from the system via the communications network 24. The ad hoc signals are typically sent by the system when the system determines that there is an imminent blackout, brownout, or dip in the system. The ad hoc signals can disable one or more user devices and can be sent and received at any point in the day. The request world 194 provides an intermediate level of access to the system 10. In an example embodiment, users of the request world 194 typically would buy one or more hardware devices that interface with the system 10 (See FIG. 17). The request world 194 can, for example, allow the users access to complex trading activities. Additionally, the request world 194 allows the users to add API software modules that carry out some limited programming and customization.

The restricted world 196 provides a full level of access to the system 10. (Typically, users subscribing to the restricted world 196 are supplied with a kit that interfaces with the users' existing power distribution panel. This black box can include one or more of the following: power conditioners, software modules, safety and monitoring sensors. Once the user's kit in installed, the user can fully utilize the system 10 and participate in the meta-exchange and carry out trading activities for both green electrons and carbon credits.

Users of any of the worlds can purchase green energy equipment through the system. For example, one page of the website can be a “shopping” page where the users can purchase or trade additional green energy equipment.

Additionally, the various levels of access can provide the users different capabilities in load shedding. Users of the free world 192 and request world 194 can motivate other users within the community to load shed at certain fixed times throughout the day through the meta-exchange in return for discounted energy. Additionally, users in the “request world” can reap additional profits through offering grid protection services such as helping to prevent blackouts, brown outs, dips in the power supply, and other irregularities. Grid sensors can sense the grid conditions and cause user devices, such as appliances consuming a lot of energy (e.g., those with motors), to shutdown until the grid is stabilized.

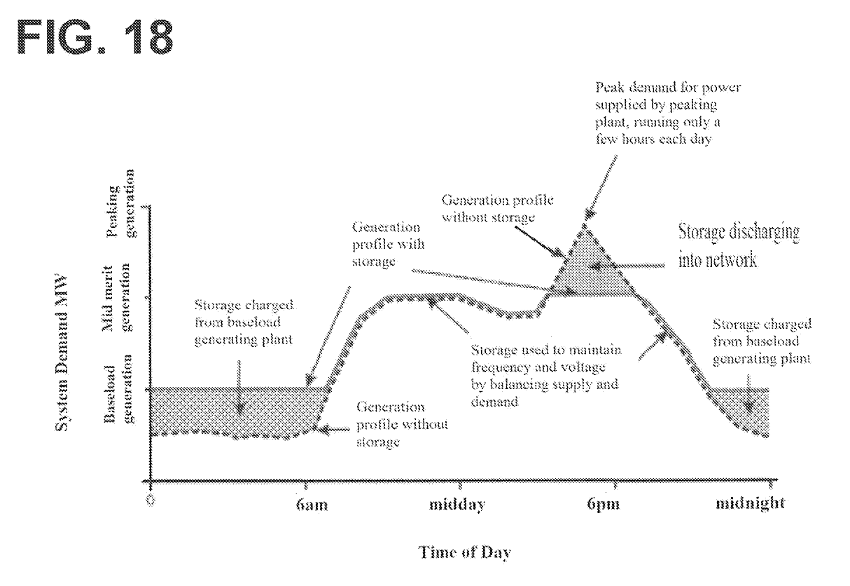

Additionally, the preferences can include whether or not the user wants the server 20 to send ad hoc signals to the user devices to power off one or more devices during a grid irregularity. If the user does want to receive such signals to temporarily disable one or more of his devices, the user can further specify which devices can be turned off and for how long (see FIG. 18). If no duration is specified, then the user devices remain powered off until the grid becomes more stable, at which point the system sends one or more signals to the user devices to reactivate them. Grid sensors can tell the home network that the power grid 14 is back to normal operating conditions. For example, after a power outage the grid sensors can relay a signal to the HAN that the power grid is operating normally, and the HAN, in turn, can send a “restore” signal to one or more of the user devices. Thus, the systems of the present invention can help improve the grid's capability of maintaining sustainability and provide power injection from customer sited generation.

FIG. 17 is a schematic diagram illustrating an example of a typical remote connection diagram for the power monitoring system of the present invention, as shown in FIGS. 2, 3A and 4. Typically, users subscribing to the restricted world 64 are supplied with a kit that interfaces with the users' existing power distribution panel. (See FIG. 1C below) This black box can include one or more of the following: power conditioners, software modules, safety and monitoring sensors. Once the user's kit in installed, the user can fully utilize the system 10 and participate in the meta-exchange and carry out trading activities for both green electrons and carbon credits.

FIG. 18 is a schematic diagram illustrating an example of the changes in our charging and discharging through a typical day for the power monitoring system of the present invention, as shown in FIGS. 2, 3A and 4. In an alternative embodiment, the system 10 can be configured to request that all renewable energy devices 18 in the system discharge their energy into the power grid 14 at one or more times throughout the day based on FIG. 18. Such times can be predetermined or preprogrammed or such times can be set as desired. In such embodiment, there would be no switching or trunking. Thus, the present invention permits the collective power of small clean energy power sources to aggregate and make up megawatt power.

Preferably, since this meta-exchange can be based on a web 2.0 model, there are no scheduled software releases, licensing or sale of the technology, but rather just usage by the users. There is also preferably no need for the software to port to different equipment so that it will be compatible with, for example, MACINTOSH® and PC software (and hence eliminate the risk of “dead end” products).

In another embodiment, the power monitoring system 200 can act as a dispatcher/controller based on the user-preferred information stored in a web 2.0 database. While it is expected that the dispatcher/controller will normally activate/deactivate the equipment according to instructions or load profiles provided by the meta-exchange, the democratized meta exchange can also automatically generate “price signaling,” both through the website as well as through mobile means, that can allow members to immediately override their default settings and start their appliances or renewable energy equipment whenever the members are offered the best available rates from the grid or other members through smart switching technology (i.e., the grid will remain competitive or face the risk of being out sold by its own members). These price signals can also include the trading price of Carbon Credits which may incentivize and drive demand for green energy.

In another embodiment, the dispatcher can also be fully decentralized and embedded into a smart switching devices within the members residential or commercial unit that can be activated directly through mobile links and cellular phone technology. Through these autonomous dispatch systems, the appropriate smart sensors can be used to take over and veto the member's normal options and switch to a self healing mode in the event of an emergency and cyber terrorist attack through an autonomous console. This autonomous dispatch system can rely on artificial intelligence, an intelligent sensor device and net metering devices to determine when energy is allowed to flow back to the grid en masse to counter such voltage dips and other instability.

The power monitoring system 200 can also include means to deploy neural network technology through interfacing with existing artificial intelligence and simulation technologies that allows decision makers to diagnose, simulate and rectify the problem whenever there are unusual swings in power instability at a specific location on the map. For example, the neural network approach can help accelerate the adoption of a digitally controlled power grid system and renewable energy systems by shifting decision-making to the fringe instead of at the center, while also mitigating the risk of cyber-attacks, power outages and instability. In this embodiment, data points including outage detection, tamper detection, load profiling, virtual shutoff algorithms can now be done at the fringes without any need to constantly communicate with the central mission control center—and non-critical demand usage readings can either be batched and sent over through POTS or continue to be read via traditional manual means. The neural network dispatcher can operate in a “running mode”. Additionally, these new neural network simulations (such as characterizing signatures from component failures and/or using fault anticipation technology) can act as an aircraft “black box” and also give investigators important new clues and details as to the cause of the instability or any accidents (e.g., provide early warning and future forecasting).

In still another embodiment, the neural network approach, a plurality of microcontrollers/dispatchers such as “INA-on-a-chip” (“Intelligent Network Agent”) is attached to each household. Each microcontroller/dispatcher is embedded with sensors and neural network software that can sense a number of variables, including the Thevenin impedance, modal phase delay, and modal power of the incoming signals from sensors that continuously monitors voltage, current, frequency, and harmonics as well as the condition of the feeders and current breakers. Upon sensing that the signals are starting to increase beyond a set threshold, the nodes fire and the software determines what levels of stored energy will be discharged in accordance with a demand management that works as a valve to gradually release or curtail power from the batteries and other renewable energy sources. Once the load reduces below a certain threshold value, the neural network algorithm starts shutting down the renewable sources and diverting them hack to charge the batteries instead. For example, if the neural network sensors detect a huge and unusual change in the impedance value, the algorithm may send an emergency signal through PLC, RF, cellular technology, or other suitable networking technology to alert the mission control center and/or the grid of a potential blackout and then switch to an emergency algorithm that includes anti-islanding and full discharge of reserve power. Similarly, the neural network algorithm has the ability to smell or sense the signature of a cyber terrorist attack and subsequently takes the necessary preemptive action such as isolating rerouting power to the other parts of the grid. Preferably, the neural network is able to adapt to the changing surroundings and environment, even without any feedback available.

In a typical embodiment, the neural network system includes an advanced impedance detection sensor, a neural network software system, an intrusion detection system, a network healing smart fiber optic switch, and a communications module, as discussed in more detail below.

An impedance detection algorithm is for use in a distributed generation (DG) network employing impedance measurement, with the capability to detect both positive and negative Thevenin sequence impedance, can be used.

Naturally occurring and injected components can be measured in a distributed generator and be correlated to the system Thevenin impedance. In an example embodiment of the present invention, the sensors can be positioned at the point of electrical coupling of the DG system. In this example embodiment, the system is integrated into the building directly through an inverter connected to a transformer on the main bus of the building and both the positive and negative impedance detection can be used directly by the inverter (i.e., the inverter can inject negative sequence components into the network to measure negative sequence components). The positive and negative sequence injection technique can be performed by lowering the voltage on each phase individually for several cycles. Steady state conditions for the experimental simulations can also set so that there is nearly zero power flowing from the utility to the building. Individually unbalancing each phase and subsequently measuring the positive and negative sequence injection technique can provide a more accurate impedance averaging technique to be employed.

Neural networks can be used for data processing purposes to give the best response when there are a plurality of complexly related input parameters even though the relation between the individual input parameters is not necessarily known. This process or algorithm is extremely advantageous when no such linear relationship exists. For example, a neural network for use in pattern recognition, and this network is based on feedback, since the learning experience is iterative, which means that the pattern concerned and the subsequent intermediate result patterns are run through the network. In accordance with an example embodiment of the present invention, the algorithms can be used with the neural network so that neural network can self adapt and self-learn. Moreover, this neural network can provide self-calibration and adaptability to new conditions as well as to new or changed surroundings. In an example embodiment, the number of firings determines the size of the threshold values so that if the numbers exceeds a certain value, the threshold value signal is increased, and if the number of firings is below the value, the threshold value signal is reduced, which number of firings from a network region also determines the size of the strength signal which is responsive to a signal applied to the network from an external systems. This provides a neural network, which without being set to a specific task in advance currently adapts itself. This also takes place in the performance of a task. Neural network software exists for simulation, research and to develop and apply artificial neural networks and a wider array of adaptive systems. Commonly used simulation software includes SNNS, Emergent, JavaNNS and Neural Lab.

In an example embodiment, an intrusion detection system monitors and senses the modal phase delay and the loss of power in a microwave signal in order to detect intrusions. An exemplary intrusion detection system, which makes use of a light signal launched into the fiber at a location spaced from the source through a single mode fiber to establish a narrow spectral width, under-filled non-uniform mode field power distribution in the fiber. A small portion of the higher order signal modes at the second location also spaced from the destination is sampled by a tap coupler and monitored for transient changes in the mode field power distribution which are characteristic of intrusion to activate an alarm. Another exemplary intrusion detection system makes use of a guard signal transmitted over the fiber optic communication link and both modal power and modal phase delay are monitored. Intrusions to the link for the purpose of intercepting information being transmitted causes changes in modal phase delay and power to the guard signal and can be monitored and detected by the monitoring system. Yet another exemplary intrusion detection system, makes use of a light source, an optical splitter, a plurality of detectors for detecting light power values split by the optical fiber. The system determines intrusion by measuring and detecting the split light value power with each other in order to detect jamming and imposter nodes. Nodes that detect the presence of an intruder transmit an emergency packet during the emergency time window to inform the receive node that the packet it received was sent from an imposter node. Attempts to jam the transmission of the emergency packet from the victim node to the receive node are detected by listening during the emergency window time period for carrier signal that indicates that an emergency packet is trying to be sent. An emergency packet request message is sent by the receive node in response which causes the victim node to resend the emergency packet. In an example embodiment of the present invention, the output of the neural network system controls the switch used to divert the signals to another light pipe.

A network healing smart fiber optic switch can be used for fast automatic switching between multiple paths of an optical transmission line with minimal disruption. This network healing smart optical switch accepts multiple fiber optic inputs and splits each optical signal into primary and secondary signals. The primary optical signals go to an optical switch which selects the primary optical signal to send to the output based on a control signal from a controller, and based on the relative signal strength of the secondary optical signals, the controller outputs of the secondary optical signals to the optical switch. The controller is in communication with a remote controller or another controller and the controller's output signal to the optical switch can be overridden by the remote controller or other controller. The network healing smart fiber optics switch automatically senses the condition, including faults on fiber optics cables and switches between fiber optics cables. In an example embodiment of the present invention, the switching occurs automatically and quickly with minimal disruption to the transmitted signal according the backpropagation algorithm where the output of the neural network system is the signal to divert the signals to another light pipe.

In another embodiment, a switch can be employed. A photochromic material is positioned within the first light pipe is illuminated by suitable wavelength of light emission source during an intrusion, thereby diverting the transmission of light signal. Using a suitable technique to divert the light signal from the first light pipe through an interconnecting second light pipe and the light information signal transverses a second photochromic material within the second light pipe which is left transparent. The light pipes within the fiber optic cables are strategically interlinked and configured with numerous inter-connections, which will allow a light information signal to be dynamically rerouted to an unused adjacent or nearby light pipe, therefore allowing a light information to circumvent the hacked light pipe and continue its destination along the fiber optic cable.

The system can further include one or more communications modules, such as plug-in interface modules that are commercially available and correspond to a variety of different commercially available PLC, LAN, WAN or SCADA communication devices. These communication devices can provide a communication link directly from the neural network systems to either the mission control center, the utility service provider or between the different neural network systems. The system can further include a narrow band personal communications service (PCS) interface module and power line carrier (PLC) interface module powered by a PLC interface power supply. These communication interface modules are easily interchangeable within the neural network unit. These modules communicate with the measurement microcontroller and the interface microcontroller along a common backplane or busing.

In summary, the impedance and anti-intrusion sensors of the present invention will work in tandem with other sensors and light) to provide the inputs for the example embodiment of this invention. Using a suitable neural network algorithm such as the Backpropagation approach, the control parameters or threshold values determine whether the neuron fires or applies an electric pulse after having received corresponding pulses from other neurons, and the strength and amplitude of the individual pulses fired. The Backpropagation approach can be described as follows:

Present a training sample to the neural network. (1) Compare the network's output to the desired output from that sample. Calculate the error in each output neuron. (2) For each neuron, calculate what the output should have been, and a scaling factor, how much lower or higher the output must be adjusted to match the desired output. This is the local error. (3) Adjust the weights of each neuron to lower the local error. (4) Assign “blame” for the local error to neurons at the previous level, giving greater responsibility to neurons connected by stronger weights. (5) Repeat from step 3 on the neurons at the previous level, using each one's “blame” as its error.

An input data signal containing both desired and undesired data i.e., if the entire grid is undergoing stress, the process system will self adjust and release the energy stored in the Distributed Grids and renewable energy sources) is submitted to the system network. In other words, the grid can have the option to increase and decrease power flow in specific and particular lines, alleviating system congestion through these solid-state power flow controllers. The size of the threshold value can be determined in such a way that if the number of firings exceeds a certain value, the threshold value signal is increased and if the number of firings is below the value, the threshold value signal is reduced. The number of firings determines the size and strength signal, which is responsive to a signal applied to a network from an external system. This provides a system, where the neural network without being set to a specific task in advance, has the ability to adapt itself.

Optionally, the components of the neural network can also be automatically or manually switched to “standalone system” mode that can act purely as an anti-islanding sensor or fiber optic self healing algorithm to protect the distributed generation network and the grid from abnormal or unstable conditions. Such abnormal or unstable conditions can include over voltages, unbalanced currents, abnormal frequency, and breaker reclosures. These conditions can happen very quickly causing generator failure, in which case green electrical power would be beneficial. The neural network can also early detect an electrical fault and trigger a self healing algorithm (or “look ahead simulation capability”) and avert a nation-wide blackout, which will help minimize commercial and economic losses.

The predetermined privileges can be based on the level of access. In an example embodiment, there can be three levels of access, such as a “free world” 192, a “request world” 194, and a “restricted world” 196. The free world 192 provides limited access to the system 10 and subsystems 12 of the present invention. In one embodiment, users of the free world 192 can purchase (or be given) a “black box unit” that interfaces with the system's and the user's existing infrastructure and hardware and functions as a “standalone” device. When implemented, the “black box unit” provides the users certain capabilities, such as access to the discussion forum system 170, the capability to purchase backup power when there is an emergency situation, and the option to load shed for a discount on their utility bills (or for a profit). In this example embodiment where hardware is provided, users of the “free plus world” pay a monthly or yearly subscription fee for such services. In the “free” world embodiment in 192, the Meta exchange can be “free” for the users to use, and it can be configured to be automatically granted to all system users. In emergency situations, the system 10 can be configured to charge premium prices for such backup energy purchased. However, in this free world 192, limited trading of energy is possible.

The system can present users of the free plus world 192 as show in the option to configure certain preferences, such as load shedding preferences. In an example embodiment, the users log into the computer dashboard and agree to comply with certain load shedding requirements, such as receiving a signal to shut down one or more user devices during one or more specified periods. For example, the user can agree to allow the system 10 to send a signal to shut down 3-4 user devices at a predetermined time each day. Additionally, the user can have the ability to change the frequency and duration of the outages and to change which devices are turned off. In one free world embodiment, the users can purchase several fixed chunks of power from other users who own renewable energy or storage devices. However, since the free users do not have hardware associated with their subscription, the green electrons will actually not flow directly to the customers when they make these “buy” signals but they will instead be injected into the grid through net metering (or grid-tied), which will result in the power grid becoming “greener”. In this embodiment, these free world users or corporations can be given the option to accumulate carbon credits, loyalty points from credit card companies and possibly public recognition. Effectively, this concept can run independent of the power grid's participation.

In a scenario with several million homes having this HAN system working in tandem with the present invention, the present invention provides users a way to avert a blackout or brownout by preset shutdowns, based on what the utility and the homeowner agreed upon previously, once the grid sensor detects an anomaly. For example, the website can receive user inputs regarding preferences in the event of a grid irregularity (e.g., blackout, brownout, dip, etc.), and the system can store such preferences in suitable computer readable medium.

Additionally, the preferences can include whether or not the user wants to sell power or photons. When a new user of the restricted world accesses the system 10 to sell power to another user. When the user joins the meta-exchange, the user preferably installs the kit into his power distribution panel. The user can input into the website whether or not he is willing to sell his power to another user of the system (such as via automatic macros, email, mobile devices, etc.). For example, the user can indicate that he always to want sell excess power, he never wants to sell excess power, or he wants to be notified of requests for power agreeing to do so. Assuming the user wants to sell his excess power, then the system sends a signal to the user's equipment to verify that power is available as to verify other relevant information (such as history, power characteristics, priority, etc.). The “dispatch equipment”, “match identification serial number” and “advanced power electronics” modules function, in short, before transferring power, the meta-exchange queries the user's database and matches the user's details before opening the user's meter. In addition, the meta-exchange queries the system to check if the average energy from the “island” is sufficient before islanding takes place. Otherwise, the system rejects the request and stops the transfer of energy if it has already been initiated.

Then, the transfer of energy occurs when an islanding processor of the docking and interfacing system opens the relevant relays and allows the electrons or photons to flow from the selling user through the power grid and to the buying user.

Those skilled in the art will understand that various other pieces of equipment can be connected/interfaced to the grid. In an example embodiment, the system of the present invention incorporates Web 2.0 business models that provide Application Programming Interfaces (API) and services, which allow new equipment to be added to the system. Hardware, software, and/or firmware can be used to connect various devices capable of producing energy to the grid. Such devices can include, but are not limited to, vehicles, forklifts, lawn mowers, electric bikes and portable generators. Those skilled in the art will further understand that various other “grid accessories” such as trunking, software, inverters, bidirectional meters, switches, relays, etc. can be added to and incorporated into the system.

The system of the present invention can be implemented with user devices in a “grid-tie” or “off grid” configuration. Thus, users can decrease the amount of fossil fuel they consume by combining their own carbon credits their one or more renewable energy devices) with power from the grid.

While the invention has been shown and described in preferred forms, it will be apparent to those skilled in the art that many modifications, additions, and deletions can be made therein. These and other changes can be made without departing from the spirit and scope of the invention as set forth in the following claims.

1. An automated system of democratizing power, comprising: a module for receiving a plurality of user preferences concerning load shedding using a graphical user interface; and a module for implementing the user preferences during a grid irregularity.

2. The system of claim 1, wherein the user preferences are received using a graphical user interface.

3. The system of claim 2, wherein the graphical user interface provides a visual representation that enables a user to adjust individual power consuming devices.
